(19) United States
(12) Patent Application Publication
(10) Pub. No.: US 2018/0003126 A1
(43) Pub. Date: Jan. 4, 2018

(54) CYLINDER HEAD

(71) Applicant: TOYOTA JIDOSHA KABUSHIKI KAISHA, Toyota-shi, Aichi-ken (JP)

(72) Inventors: Satoko TOFUKUJI, Minato-ku, Tokyo-to (JP); Atsunori KUMAGAI, Sunto-gun, Shizuoka-ken (JP); Nobuki KAWAMOTO, Okazaki-shi, Aichi-ken (JP)

(73) Assignee: TOYOTA JIDOSHA KABUSHIKI KAISHA, Toyota-shi, Aichi-ken (JP)

(21) Appl. No.: 15/543,325

(22) PCT Filed: Nov. 18, 2015
(86) PCT No.: PCT/JP2015/005761

§ 371 Date: Jul. 13, 2017

(30) Foreign Application Priority Data
Jan. 15, 2015 (JP) 2015-005628

(51) Int. Cl. F02F 1/40; F01P 3/02; F02F 1/42

(52) U.S. Cl. CPC F02F 1/40; F02F 1/4235; F01P 3/02; F01P 2003/024

(57) ABSTRACT

A cylinder head that can efficiently cool air that flows in intake ports of respective cylinders without causing a difference among the cylinders. A cooling water channel is provided in peripheries of the intake ports in the cylinder head. The cooling water channel includes a plurality of water jackets that independently cover parts of respective wall surfaces of a plurality of intake ports. Further, the cooling water channel includes a main channel for cooling water supply that extends in a longitudinal direction of the cylinder head, on an upper part of a row of the intake ports, and the main channel and the respective water jackets are each connected via branch channels for cooling water supply.

### TECHNICAL FIELD

The present invention relates to a cylinder head of an internal combustion engine, and more particularly relates to a cylinder head that is internally equipped with a channel in which cooling water flows.

### BACKGROUND ART

In the cylinder head of an internal combustion engine, a channel in which cooling water flows is formed. Patent Literature 1 discloses providing the first cooling water circuit in which cooling water for cooling the periphery of the intake port in the cylinder head circulates, independently from the second cooling water circuit in which cooling water for cooling the periphery of the exhaust port in the cylinder block and the cylinder head circulates, in order to cool the air in the intake port.

The first cooling water circuit includes an intake port cooling water passage that is formed in the cylinder head. The intake port cooling water passage is connected to the cooling water introduction section that is provided in an end surface in the width direction of the cylinder head. The intake port cooling water passage extends to the lower side of the intake port from the cooling water introduction section, passes on the side surface of the intake port to extend to the upper side of the intake port, and passes on the upper side of the intake port to be connected to the cooling water lead-out section that is provided in the end surface in the longitudinal direction of the cylinder head. Note that the lower side of the intake port mentioned here means the lower side in the vertical direction in the case of the cylinder head being located at the upper side in the vertical direction with respect to the cylinder block, and the upper side of the intake port means the upper side in the vertical direction in the case of the cylinder head being located similarly.

### CITATION LIST

### Patent Literature

PTL 1: Japanese Patent Laid-Open No. 2013-133746

### SUMMARY OF INVENTION

### Technical Problem

In order to restrain heat reception of intake air effectively, the internal combustion engine is required to cool the wall surface of the intake port in a wide range by using cooling water with a lower temperature. Further, when a variation arises in the heat reception amounts of the intake air among cylinders in a multi-cylinder internal combustion engine, there arises the fear of causing degradation of emission and reduction in drivability due to a variation in combustion. Consequently, the structure which cools the air in the intake ports is desirably the configuration in which a variation in the cooling effect does not occur among the cylinders.

However, according to the structure of the cylinder head disclosed in Patent Literature 1, the intake port cooling water passage extends to the lower side of the intake port from the cooling water introduction section. Therefore, before the cooling water flows to the upper side of the intake port, the water temperature rises due to heat reception from the top surface of the combustion chamber which has a high temperature, and a sufficient cooling effect to the air in the intake ports is unlikely to be obtained.

Further, the intake port cooling water passage disclosed in Patent Literature 1 is configured as a cooling water passage that integrally covers the peripheries of the intake ports of a plurality of cylinders. Therefore, the cooling water which is introduced from the cooling water introduction section flows without any difference among the cylinders while receiving heat, toward the cooling water lead-out section at the end portion in the longitudinal direction of the cylinder head. In the configuration as above, a variation among the cylinders arises in the temperature of the cooling water that flow in the peripheries of the intake ports, and therefore, there arises a possibility that some cylinders do not obtain a sufficient cooling effect for the air in the intake ports.

The present invention is made in the light of the problem as described above, and has an object to provide a cylinder head that can efficiently cool air that flows in intake ports of respective cylinders without causing a difference among the cylinders.

### Solution to Problem

In accomplishing the above object, according to a first aspect of the present invention, there is provided a cylinder head for multi-cylinder engine, comprising:

a plurality of intake ports that are provided side by side in a longitudinal direction of the cylinder head;

a plurality of intake port cooling water jackets that are independently provided at the respective plurality of intake ports, and cover at least parts of respective wall surfaces of the plurality of intake ports;

a cooling water supplying main channel that is provided at an opposite side from a side of a cylinder block mating surface of the cylinder head with respect to a central trajectory surface including central trajectories of the plurality of intake ports, and extends in the longitudinal direction of the cylinder head; and

a plurality of cooling water supplying branch channels that connect the cooling water supplying main channel and the respective plurality of intake port cooling water jackets.

According to the second aspect of the present invention, there is provided the cylinder head as described in the first aspect, wherein

the intake port includes a first branch port and a second branch port that are connected to a common combustion chamber,

the intake port cooling water jacket includes a first water jacket that covers a wall surface which is at the side of the cylinder block mating surface with respect to the central trajectory surface, of a wall surface of the first branch port, and a second water jacket that covers a wall surface which is at an opposite side from the side of the cylinder block mating surface with respect to the central trajectory surface, of a wall surface of the second branch port, in at least one section of sections perpendicular to the central trajectory, and

the first water jacket and the second water jacket are integrally connected in a region between the first branch port and the second branch port.

According to the third aspect of the present invention, there is provided the cylinder head as described in the second aspect, wherein

the cooling water supplying branch channel is connected to a portion of the first water jacket, which covers a side surface at an opposite side from the second branch port, of the first branch port, and

a cooling water discharging channel is connected to a portion of the second water jacket, which covers a side surface at an opposite side from the first branch port, of the second branch port.

According to the fourth aspect of the present invention, there is provided the cylinder head as described in the second or third aspect, further comprising:

an auxiliary channel that connects a top portion in a vertical direction, of the first water jacket, and the cooling water supplying main channel.

According to the fifth aspect of the present invention, there is provided the cylinder head as described in any one of the second to fourth aspects, further comprising:

an auxiliary channel that connects a top portion in a vertical direction, of the second water jacket, and the cooling water supplying main channel.

According to the sixth aspect of the present invention, there is provided the cylinder head as described in the fourth or the fifth aspect, wherein

a channel sectional area of the auxiliary channel is smaller than a channel sectional area of the cooling water supplying branch channel.

According to the seventh aspect of the present invention, there is provided the cylinder head as described in the first aspect, wherein

the intake port cooling water jacket includes, in at least one section of sections perpendicular to the central trajectory,

a first side surface water jacket that covers a first position on one side that intersects the central trajectory surface, of a wall surface of the intake port, and

a second side surface water jacket that is configured as a separate piece from the first side surface water jacket, and covers a second position on the other side that intersects the central trajectory surface, of the wall surface of the intake port.

According to the eighth aspect of the present invention, there is provided the cylinder head as described in the first aspect, wherein

the intake port cooling water jacket is provided to cover at least a wall surface which is at the side of the cylinder block mating surface with respect the central trajectory surface, of a wall surface of the intake port, in at least one section of sections perpendicular to the central trajectory.

According to the ninth aspect of the present invention, there is provided the cylinder head as described in the first aspect, wherein

the intake port cooling water jacket covers at least a wall surface which is at the opposite side from the side of the cylinder block mating surface with respect to the central trajectory surface, of a wall surface of the intake port, in at least one section of sections perpendicular to the central trajectory.

According to the tenth aspect of the present invention, there is provided the cylinder head as described in the first aspect, wherein

the intake port cooling water jacket is provided to surround a whole circumference of the intake port.

According to the eleventh aspect of the present invention, there is provided the cylinder head as described in the seventh aspect, wherein

the cooling water supplying branch channels are each connected to opposite sides from the side of the cylinder block mating surface with respect to the central trajectory surface, of the first side surface water jacket and the second side surface water jacket, and

cooling water discharging channels are each connected to sides of the cylinder block mating surface with respect to the central trajectory surface, of the first side surface water jacket and the second side surface water jacket.

According to the twelfth aspect of the present invention, there is provided the cylinder head as described in the eleventh aspect, further comprising:

auxiliary channels that connect respective top portions in the vertical direction of the first side surface water jacket and the second side surface water jacket, and the cooling water supplying main channel.

According to the thirteenth aspect of the present invention, there is provided the cylinder head as described in the twelfth aspect, wherein

wherein the auxiliary channel is a channel with a channel sectional area smaller than a channel sectional area of the cooling water supplying branch channel.

According to the fourteenth aspect of the present invention, there is provided the cylinder head as described in any one of the eighth to tenth aspects, wherein

the cooling water supplying branch channel is connected to an opposite side from the side of the cylinder block mating surface with respect to the central trajectory surface, of the intake port cooling water jacket, and

a cooling water discharging channel is connected to a side of the cylinder block mating surface with respect to the central trajectory surface, of the intake port cooling water jacket.

According to the fifteenth aspect of the present invention, there is provided the cylinder head as described in the fourteenth aspect, further comprising:

an auxiliary channel that connects a top portion in the vertical direction of the intake port cooling water jacket, and the cooling water supplying main channel.

According to the sixteenth aspect of the present invention, there is provided the cylinder head as described in the fifteenth aspect, wherein

a channel sectional area of the auxiliary channel is smaller than a channel sectional area of the cooling water supplying branch channel.

### ADVANTAGEOUS EFFECTS OF INVENTION

According to the first invention, the water jackets for cooling intake ports are each provided independently at the plurality of intake ports. The respective water jackets are provided to cover at least parts of the wall surfaces of the respective intake ports. Further, the main channel for cooling water supply is provided to extend in the longitudinal direction of the cylinder head, and the water jackets of the respective intake ports are connected to the main channel via the respective branch channels for cooling water supply. Consequently, according to the present invention, the cooling water can be introduced in parallel into the water jackets of the respective intake ports from the main channel, and therefore, the air that flows in the intake ports of the respective cylinders can be cooled without causing a difference among the cylinders. Further, according to the present invention, the main channel for cooling water supply is provided at the opposite side from the side of the mating surface of the cylinder head with the cylinder block with respect to the central trajectory surface. Consequently, a rise in the temperature of the cooling water which flows in the main channel due to heat reception from the top surface of the combustion chamber which has a high temperature can be restrained, and therefore the air which flows in the intake ports of the respective cylinders can be efficiently cooled.

According to the second invention, the wall surface in a wide range including the space between the first branch port and the second branch port can be integrally covered with the water jacket, and therefore the air which flows in the intake port of each of the cylinders can be efficiently cooled.

According to the third invention, the cooling water which flows in the cooling water supplying main channel is introduced from the side surface at the opposite side from the side of the second water jacket, of the first water jacket. The cooling water which is introduced into the first water jacket flows into the second water jacket, and is discharged from the side surface at the opposite side from the side of the first water jacket, of the second water jacket. Consequently, according to the present invention, the cooling water can be restrained from stagnating inside the water jacket, and therefore, the range of the wall surface of the intake port which is covered with the water jacket can be efficiently cooled.

According to the fourth invention, the top portion in the vertical direction of the first water jacket and the cooling water supplying main channel are connected by means of the auxiliary channel, and therefore, the air which is trapped in the first water jacket can be caused to flow to the cooling water supplying main channel. Consequently, according to the present invention, generation of an air accumulation in the first water jacket can be restrained, and therefore, reduction in the cooling efficiency can be restrained.

According to the fifth invention, the top portion in the vertical direction of the second water jacket and the cooling water supplying main channel are connected by means of the auxiliary channel, and therefore, the air which is trapped in the second water jacket can be caused to flow to the cooling water supplying main channel. Consequently, according to the present invention, generation of an air accumulation in the second water jacket can be restrained, and therefore, reduction in the cooling efficiency can be restrained.

According to the sixth invention, the auxiliary channel is configured as the channel with the channel sectional area smaller than the channel sectional area of the cooling water supplying branch channel. Consequently, according to the present invention, the flow of the cooling water which flows from the cooling water supplying main channel to the water jacket via the auxiliary channel can be restricted, and therefore stagnation of the cooling water due to disturbance of the water flow in the water jacket can be effectively restrained.

According to the seventh invention, the wall surface in the wide range including the position which intersects the central trajectory surface, of the wall surface of the intake port can be covered with the water jacket, in at least one section of the sections perpendicular to the central trajectory, and therefore, the air which flows in the intake port of each of the cylinders can be efficiently cooled.

According to the eighth invention, the undersurface of the intake port which is at least the wall surface which is at the side of the cylinder block mating surface with respect the central trajectory surface, of the wall surface of the intake port is covered with the water jacket, in at least one section of the sections perpendicular to the central trajectory. Consequently, according to the present invention, heat reception by the air, which flows in the intake port, from the top surface of the combustion chamber which has a high temperature can be effectively restrained in the wide range.

According to the ninth invention, the top surface of the intake port which is at least the wall surface which is at the opposite side from the side of the cylinder block mating surface with respect to the central trajectory surface, of the wall surface of the intake port is covered with the water jacket, in at least one section of the sections perpendicular to the central trajectory. Consequently, according to the present invention, the air which flows in such a manner as to stick to the top surface side of the intake port especially at the time of generation of a tumble flow can be effectively cooled in the wide range.

According to the tenth invention, the whole circumference of the intake port is surrounded by the water jacket, in at least one section of the sections perpendicular to the central trajectory. Consequently, according to the present invention, the wall surface in the wide range of the intake port can be covered with the water jacket, and therefore the air which flows in the intake port of each of the cylinders can be efficiently cooled.

According to the eleventh invention, the cooling water can be introduced into the first side surface water jacket and the second side surface water jacket independently from the main channel, and therefore, the air which flows in the intake port of each of the cylinders can be efficiently cooled.

According to the twelfth invention, the respective top portions in the vertical direction of the first side surface water jacket and the second side surface water jacket are each connected to the cooling water supplying main channel by means of the auxiliary channels. Consequently, according to the present invention, the air which is trapped in the first side surface water jacket and the second side surface water jacket can be caused to flow to the cooling water supplying main channel. Consequently, generation of an air accumulation in the first side surface water jacket and the second side surface water jacket can be restrained, and therefore, reduction in the cooling efficiency can be restrained.

According to the thirteenth invention, the auxiliary channel is configured as the channel with the channel sectional area smaller than the channel sectional area of the cooling water supplying branch channel. Consequently, according to the present invention, the flow of the cooling water which flows to the water jacket from the cooling water supplying main channel via the auxiliary channel can be restricted, and therefore, stagnation of the cooling water due to disturbance of the water flow in the water jacket can be effectively restrained.

According to the fourteenth invention, the cooling water is caused to flow from the region at the upper side which is at the opposite side from the side of the cylinder block mating surface with respect to the central trajectory surface to the region at the lower side which is at the side of the cylinder block mating surface. Consequently, according to the present invention, the cooling water can be restrained from stagnating inside the water jacket, and therefore, the range of the intake port which is covered with the water jacket can be efficiently cooled.

According to the fifteenth invention, the top portion in the vertical direction of the water jacket and the cooling water supplying main channel are connected by means of the auxiliary channel. Consequently, according to the present invention, the air which is trapped in the water jacket can be caused to flow to the cooling water supplying main channel. Consequently, generation of an air accumulation in the water jacket can be restrained, and therefore reduction in the cooling efficiency can be restrained.

According to the sixteenth invention, the auxiliary channel is configured as the channel with the channel sectional area smaller than the channel sectional area of the cooling water supplying branch channel. Consequently, according to the present invention, the flow of the cooling water which flows from the cooling water supplying main channel to the water jacket via the auxiliary channel can be restrained, and therefore stagnation of the cooling water due to disturbance of the water flow in the water jacket can be effectively restrained.

### BRIEF DESCRIPTION OF DRAWINGS

FIG. 1 is a plan view of a cylinder head of embodiment 1 of the present invention.

FIG. 2 is a sectional view of a section taken along A to A in FIG. 1, that is a section which includes a central axis of an intake valve insertion hole, and is perpendicular to a longitudinal direction of the cylinder head of embodiment 1 of the present invention.

FIG. 3 is a sectional view of a section taken along B to B in FIG. 1 that is a section which includes a central axis of a combustion chamber, and is perpendicular to the longitudinal direction of the cylinder head of embodiment 1 of the present invention.

FIG. 4 is a sectional view showing a section taken along C to C in FIG. 1, that is a section which passes between two adjacent combustion chambers, and is perpendicular to the longitudinal direction of the cylinder head of embodiment 1 of the present invention.

FIG. 5 is a perspective view in which intake ports and a cooling water channel of the cylinder head of embodiment 1 of the present invention are drawn by being seen through from above an intake side.

FIG. 6 is a perspective view in which the intake ports and the cooling water channel of the cylinder head of embodiment 1 of the present invention are drawn by being seen through from a direction along a trajectory central line.

FIG. 7 is a perspective view in which the intake ports and the cooling water channel of the cylinder head of embodiment 1 of the present invention are drawn by being seen through from above an exhaust side.

FIG. 8 is a perspective view in which the intake ports and the cooling water channel of the cylinder head of embodiment 1 of the present invention are drawn by being seen through from below the intake side.

FIG. 9 is a perspective view of the intake ports and an intake port central trajectory surface of the cylinder head of embodiment 1 of the present invention.

FIG. 10 is a side view showing the intake port and a central trajectory thereof of the cylinder head of embodiment 1 of the present invention.

FIG. 11 is a perspective view showing a modification of the intake ports and a central trajectory surface of the intake ports.

FIG. 12 is a perspective view showing a modification of the intake ports and an intake port central trajectory surface thereof.

FIG. 13 is a side view of a modification of the intake port and a central trajectory thereof.

FIG. 14 is a sectional view of the intake ports which are cut along a surface that is perpendicular to the central trajectory of the intake ports.

FIG. 15 is a sectional view of the intake ports as a modification which are cut along a surface that is perpendicular to a central trajectory of the intake ports.

FIG. 16 is a perspective view in which intake ports and a cooling water channel of a cylinder head of embodiment 2 of the present invention are drawn by being seen through from above an intake side.

FIG. 17 is a perspective view in which the intake ports and the cooling water channel of the cylinder head of embodiment 2 of the present invention are drawn by being seen through from a direction along a trajectory central line.

FIG. 18 is a perspective view in which intake ports and a cooling water channel of a cylinder head of embodiment 3 of the present invention are drawn by being seen through from above an exhaust side.

FIG. 19 is a perspective view in which the intake ports and the cooling water channel of the cylinder head of embodiment 3 of the present invention are drawn by being seen through from below an intake side.

FIG. 20 is a perspective view in which intake ports and a cooling water channel of a cylinder head of embodiment 4 of the present invention are drawn by being seen through from above an intake side.

FIG. 21 is a perspective view in which the intake ports and the cooling water channel of the cylinder head of embodiment 4 of the present invention are drawn by being seen through from a direction along a trajectory central line.

FIG. 22 is a perspective view in which the intake ports and the cooling water channel of the cylinder head of embodiment 4 of the present invention are drawn by being seen through from below the intake side.

FIG. 23 is a perspective view in which intake ports and a cooling water channel of a cylinder head of embodiment 5 of the present invention are drawn by being seen through from above an intake side.

FIG. 24 is a perspective view in which the intake ports and the cooling water channel of the cylinder head of embodiment 5 of the present invention are drawn by being seen through from a direction along a trajectory central line.

FIG. 25 is a perspective view in which the intake ports and the cooling water channel of the cylinder head of embodiment 5 of the present invention are drawn by being seen through from above an exhaust side.

FIG. 26 is a perspective view in which the intake ports and the cooling water channel of the cylinder head of embodiment 5 of the present invention are drawn by being seen through from below the intake side.

FIG. 27 is a perspective view in which intake ports and a cooling water channel of a cylinder head of embodiment 6 of the present invention are drawn by being seen through from above an intake side.

FIG. 28 is a perspective view in which the intake ports and the cooling water channel of the cylinder head of embodiment 6 of the present invention are drawn by being seen through from a direction along a trajectory central line.

FIG. 29 is a perspective view in which the intake ports and the cooling water channel of the cylinder head of embodiment 6 of the present invention are drawn by being seen through from above an exhaust side.

FIG. 30 is a perspective view in which intake ports and a cooling water channel of a cylinder head of embodiment 7 of the present invention are drawn by being seen through from above an intake side.

FIG. 31 is a perspective view in which the intake ports and the cooling water channel of the cylinder head of embodiment 7 of the present invention are drawn by being seen through from a direction along a trajectory central line.

FIG. 32 is a perspective view in which the intake ports and the cooling water channel of the cylinder head of embodiment 7 of the present invention are drawn by being seen through from above an exhaust side.

FIG. 33 is a perspective view in which the intake ports and the cooling water channel of the cylinder head of embodiment 7 of the present invention are drawn by being seen through from below the intake side.

FIG. 34 is a perspective view in which intake ports and a cooling water channel of a cylinder head of embodiment 8 of the present invention are drawn by being seen through from above an intake side.

FIG. 35 is a perspective view in which the intake ports and the cooling water channel of the cylinder head of embodiment 8 of the present invention are drawn by being seen through from a direction along a trajectory central line.

FIG. 36 is a perspective view in which the intake ports and the cooling water channel of the cylinder head of embodiment 8 of the present invention are drawn by being seen through from above an exhaust side.

FIG. 37 is a perspective view in which intake ports and a cooling water channel of a cylinder head of embodiment 9 of the present invention are drawn by being seen through from below an exhaust side.

### DESCRIPTION OF EMBODIMENTS

Embodiments of the present invention will be described with reference to the drawings. Note that the embodiments which are shown as follows illustrate devices and methods for embodying the technical idea of the present invention, and do not intend to limit structures and disposition of components, sequences of processings and the like to those described as follows, unless especially explicitly shown otherwise. The present invention is not limited to the embodiments which are shown as follows, and can be carried out by being variously modified within the range without departing from the gist of the present invention.

### Embodiment 1

Hereinafter, embodiment 1 of the present invention will be described with use of the drawings. As the preconditions of embodiment 1, an engine is a spark ignition type water-cooled in-line three-cylinder engine. Further, cooling water for cooling the engine is circulated between the engine and a radiator by a circulation system. The engine is equipped with a cylinder block, and a cylinder head that is mounted on the cylinder block via a gasket. Supply of the cooling water is performed for both the cylinder block and the cylinder head. The circulation system is an independent closed loop, and is equipped with a radiator and a water pump. These preconditions are also applied to embodiments 2 to 10 that will be described later. However, when the present invention is applied to the engine, the number of cylinders and cylinder disposition of the engine, and an ignition method of the engine are not limited as long as the engine is a multi-cylinder engine. Further, as for a configuration of the circulation system, the circulation system may be configured as a multiple-system circulation system that is equipped with a plurality of independent closed loops.

### <<Basic Configuration of Cylinder Head of Embodiment 1>

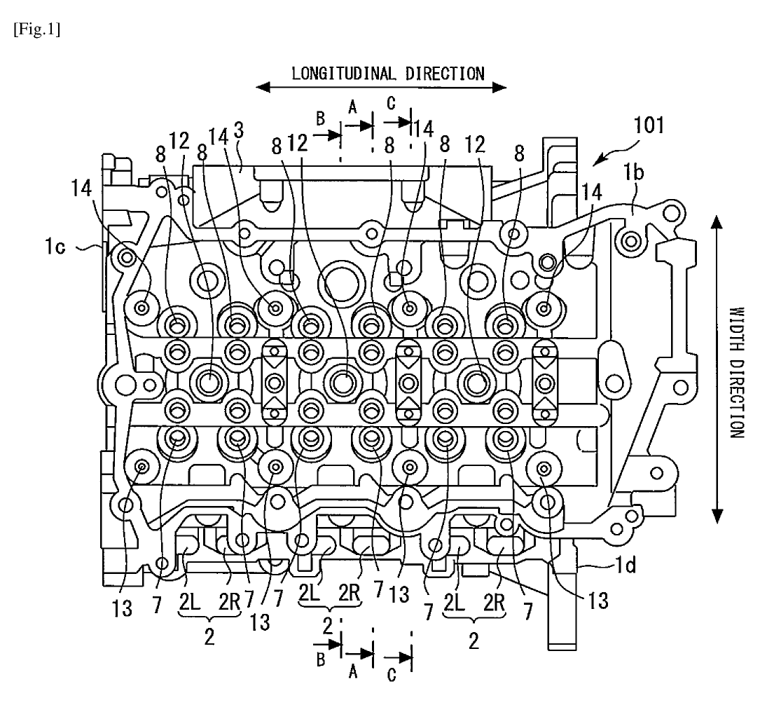

Hereinafter, with reference to FIG. 1 to FIG. 4, a basic configuration of a cylinder head 101 of embodiment 1 will be described. Explanation will be made with use of a plan view and sectional views of the cylinder head 101. In the cylinder head 101, three intake ports 2 for three cylinders are formed. Note that in the present description, positional relations among respective elements will be described on the assumption that the cylinder head 101 is located at an upper side in a vertical direction with respect to a cylinder block, unless specially described otherwise. The assumption is for the purpose of simply making the explanation understandable, and the assumption does not add any restrictive meaning to the configuration of the cylinder head according to the present invention. Of the configuration of the cylinder head 101, explanation of a configuration of a cooling water channel will be described in detail later.

### <<Basic Configuration of Cylinder Head Seen in Plan View>>

FIG. 1 is a plan view of the cylinder head 101 of embodiment 1. In more detail, FIG. 1 is a plan view of the cylinder head 101 seen from a side of a head cover mounting surface 1b on which a head cover is mounted. Consequently, a cylinder block mating surface to be a back surface is invisible in FIG. 1. Note that in the present description, an axial direction of a crankshaft is defined as a longitudinal direction of the cylinder head 101, and a direction that is orthogonal to the longitudinal direction, and is parallel with the cylinder block mating surface of the cylinder head 101 is defined as a width direction of the cylinder head 101. Further, out of end surfaces 1c and 1d in the longitudinal direction, the end surface 1d at a side of an output end of the crankshaft is referred to as a rear end surface, and the end surface 1c at an opposite side thereof is referred to as a front end surface.

The cylinder head 101 of embodiment 1 is a cylinder head of a spark ignition type inline three-cylinder engine. In an undersurface (the mating surface with the cylinder block) of the cylinder head 101, three combustion chambers for the three cylinders are formed side by side equidistantly in series in the longitudinal direction, though not illustrated in FIG. 1. In the cylinder head 101, ignition plug insertion holes 12 are formed in the respective combustion chambers.

Intake ports 2 and an exhaust port 3 are opened to side surfaces of the cylinder head 101. In more detail, the intake ports 2 are opened to a right side surface of the cylinder head 101 seen from a side of the front end surface 1c, and the exhaust port 3 is opened to a left side surface. Hereinafter, in the present description, a side surface that is located at a right side when the cylinder head 101 is seen from the side of the front end surface 1c will be referred to as a right side surface of the cylinder head 101, and a side surface that is located at a left side will be referred to as a left side surface of the cylinder head 101. The intake port 2 includes two branch ports 2L and 2R that are disposed side by side in the longitudinal direction of the cylinder head 101. The branch ports 2L and 2R extend from each of the combustion chambers, and are independently opened to the right side surface of the cylinder head 101. The exhaust ports 3 are assembled to be a single exhaust port inside the cylinder head 101, and the assembled single exhaust port 3 is opened to the left side surface of the cylinder head 101. Consequently, in the present description, a right side at a time of seeing the cylinder head 101 from the side of the front end surface 1c will be described as an intake side, and a left side will be described as an exhaust side in some cases.

The cylinder head 101 of embodiment 1 is a cylinder head of a four-valve engine in which two intake valves and two exhaust valves are each provided at each cylinder. On a top surface of the cylinder head 101, two intake valve insertion holes 7 and two exhaust valve insertion holes 8 are formed in such a manner as to surround the single ignition plug insertion hole 12. The intake valve insertion holes 7 connect to the intake port 2 inside the cylinder head 101, and the exhaust valve insertion holes 8 connect to the exhaust port 3 inside the cylinder head 101.

Inside the head cover mounting surface 1b, head bolt insertion holes 13 and 14 through which head bolts for assembling the cylinder head 101 to the cylinder block are formed. Four head bolts are provided at each of both left and right sides for a row of the combustion chambers. At the intake side, the head bolt insertion holes 13 are formed between the two adjacent intake ports 2, between the front end surface 1c and the intake port 2 which is the nearest to the front end surface 1c, and between the rear end surface 1d and the intake port 2 which is the nearest to the rear end surface 1d. At the exhaust side, the head bolts insertion holes 14 are formed in forks of the exhaust port 3 at which the exhaust port 3 branches for each of the combustion chambers, between the front end surface 1c and the exhaust port 3, and between the rear end surface 1d and the exhaust port 3.

Next, a configuration of an inside of the cylinder head 101 of embodiment 1 will be described with reference to sectional views. Sections of the cylinder head 101 to which attention is paid are a section that includes a central axis of the intake valve insertion hole 7 and is perpendicular to the longitudinal direction of the cylinder head 101 (a section taken along A to A in FIG. 1), a section that includes a central axis of the combustion chamber and is perpendicular to the longitudinal direction of the cylinder head 101 (a section taken along B to B in FIG. 1), and a section that passes through between the two adjacent combustion chambers and is perpendicular to the longitudinal direction of the cylinder head 101 (a section taken along C to C in FIG. 1).

### <<Basic Configuration of Cylinder Head Seen in Section That Includes Central Axis of Intake Valve Insertion Hole and is Perpendicular to Longitudinal Direction>>

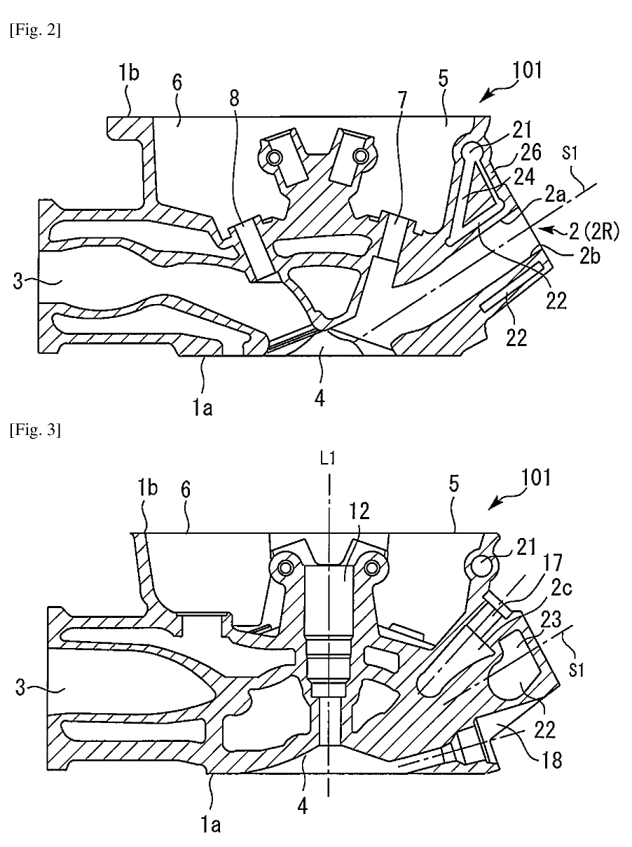

FIG. 2 is a sectional view showing the section that includes the central axis of the intake valve insertion hole 7 and is perpendicular to the longitudinal direction of the cylinder head 101 (the section taken along A to A in FIG. 1). As shown in FIG. 2, a combustion chamber 4 having a pent-roof shape is formed on a cylinder block mating surface 1a that corresponds to an undersurface of the cylinder head 101. The combustion chamber 4 configures a closed space by closing a cylinder from above when the cylinder head 101 is assembled to the cylinder block. When a closed space sandwiched by the cylinder head 101 and a piston is defined as a combustion chamber, the combustion chamber 4 can be referred to as a combustion chamber ceiling surface.

Seen from the side of the front end of the cylinder head 101, the intake port 2 is opened to an inclined surface at a right side of the combustion chamber 4. A connecting portion of the intake port 2 and the combustion chamber 4, that is, an open end at the combustion chamber side of the intake port 2 is an intake port that is opened and closed by the intake valve not illustrated. Since the two intake valves are provided in each of the cylinders, two intake holes of the intake port 2 are formed in the combustion chamber 4. An inlet of the intake port 2 is opened to a right side surface of the cylinder head 101. As described above, the intake port 2 includes the two branch ports 2L and 2R which are disposed side by side in the longitudinal direction, and the respective branch ports are each connected to the intake holes which are formed in the combustion chamber 4. In FIG. 2, the branch port 2R at the rear end side of the engine in the longitudinal direction is drawn. Note that the intake port 2 is a tumble flow generation port that can generate a tumble flow in the cylinder.

In the cylinder head 101, the intake valve insertion holes 7 for passing stems of the intake valves 11 are formed. An intake side valve mechanism chamber 5 that accommodates a valve mechanism that causes the intake valve to operate is provided inside the head cover mounting surface 1b in the top surface of the cylinder head 101. The intake valve insertion hole 7 extends straight diagonally upward from a top surface of the intake port 2 in a vicinity of the combustion chamber 4 to the intake side valve mechanism chamber 5.

Seen from the side of the front end of the cylinder head 101, the exhaust port 3 is opened to an inclined surface at a left side of the combustion chamber 4. A connecting portion of the exhaust port 3 and the combustion chamber 4, that is, an open end at a combustion chamber side of the exhaust port 3 is an exhaust hole that is opened and closed by exhaust valves not illustrated. Since two exhaust valves are provided at each of the cylinders, two exhaust holes of the exhaust port 3 are formed in the combustion chamber 4. The exhaust port 3 has a manifold shape having six inlets (exhaust holes) that are provided for the respective exhaust valves of the respective combustion chambers 4, and one outlet that is opened to a left side surface of the cylinder head 101.

In the cylinder head 101, the exhaust valve insertion holes 8 for passing stems of the exhaust valves are formed. An exhaust side valve mechanism chamber 6 that accommodates a valve mechanism that causes the exhaust valve to operate is provided inside the head cover mounting surface 1b in the top surface of the cylinder head. The exhaust valve insertion hole 8 extends straight diagonally upward to the left from a top surface of the exhaust port 3 in a vicinity of the combustion chamber 4 to the exhaust side valve mechanism chamber 6.

### <<Basic Configuration of Cylinder Head Seen in Section That Includes Central Axis of Combustion Chamber and is Perpendicular to Longitudinal Direction>>

FIG. 3 is a sectional view showing a section (a section taken along B to B in FIG. 1) that includes a central axis L1 of the combustion chamber 4 and is perpendicular to the longitudinal direction of the cylinder head 101. In the cylinder head 101, the ignition plug insertion hole 12 for mounting an ignition plug is formed. The ignition plug insertion hole 12 is opened to a top portion of the combustion chamber 4 having the pent-roof shape. The central axis L1 of the combustion chamber 4 coincides with a central axis of the cylinder when the cylinder head 101 is assembled to the cylinder block.

The intake ports 2 are located at both sides of the plane that includes the central axis L1 of the combustion chamber 4 and is perpendicular to the longitudinal direction, and therefore, are not included in the section shown in FIG. 3. Further, in the section shown in FIG. 3, a part of the exhaust port 3 having the manifold shape is expressed. The congregated part of the exhaust port 3 is opened to the left side surface of the cylinder head 101.

A port injector insertion hole 17 for mounting a port injector is formed at an upper side from the intake port 2, in the side surface of the cylinder head 101. A central axis of the port injector insertion hole 17 is located on a plane that includes the central axis L1 of the combustion chamber 4 and is perpendicular to the longitudinal direction. The port injector insertion hole 17 intersects the intake port 2 at an acute angle, and is opened to a port injector mounting portion 2c that is formed to protrude upward on a top surface of a branch portion of the intake port 2. The port injector (not illustrated) that is inserted into the port injector insertion hole 17 exposes a nozzle tip end from the port injector mounting portion 2c, and injects fuel into the intake port 2.

A cylinder direct injection injector insertion hole 18 for mounting a cylinder direct injection injector is formed at a lower side from the intake port 2 in the side surface of the cylinder head 101. A central axis of the cylinder direct injection injector insertion hole 18 is located on a plane that includes the central axis L1 of the combustion chamber 4 and is perpendicular to the longitudinal direction. The cylinder direct injection injector insertion hole 18 is opened to the combustion chamber 4. Fuel is directly injected into the cylinder from the cylinder direct injection injector (not illustrated) which is inserted into the cylinder direct injection injector insertion hole 18.

### <<Basic Configuration of Cylinder Head Seen in Section That Passes Between Two Adjacent Combustion Chambers and is Perpendicular to Longitudinal Direction>>

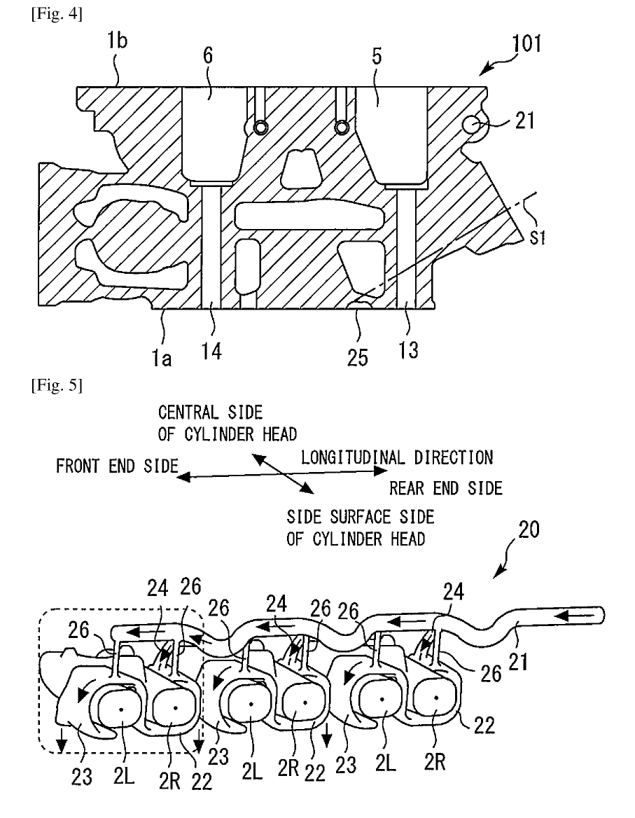

FIG. 4 is a sectional view showing a section (a section taken along C to C in FIG. 1) that passes between two adjacent combustion chambers and is perpendicular to the longitudinal direction of the cylinder head 101. In the cylinder head 101, the head bolt insertion hole 13 at the intake side is formed vertically downward from the intake side valve mechanism chamber 5. Further, the head bolt insertion hole 14 at the exhaust side is formed vertically downward from the exhaust side valve mechanism chamber 6. The head bolt insertion holes 13 and 14 are perpendicular to the cylinder block mating surface 1a, and are opened to the cylinder block mating surface 1a. The section shown in FIG. 4 is a section that includes central axes of the head bolt insertion holes 13 and 14 and is perpendicular to the longitudinal direction.

Next, a configuration of the cooling water channel of the cylinder head 101 of embodiment 1 will be described. Explanation is made with use of the sectional views of the cylinder head 101, and perspective views of the cooling water channel inside the cylinder head 101 drawn by being seen through.

### <Configuration of Cooling Water Channel of Cylinder Head of Embodiment 1>

### <<Definition of Reference Surfaces and Reference Points>>

First of all, prior to explanation of the configuration of the cylinder head cooling water channel, reference surfaces and reference points of the cylinder head that are used in the explanation are defined here. The reference surfaces and the reference points which are defined here are also applied to embodiments 2 to 10 that will be described later.

1. Cylinder Block Mating Surface (First Reference Surface)

The cylinder block mating surface 1a shown in FIG. 2, FIG. 3 and FIG. 4 is a first reference surface. The cylinder block mating surface 1a becomes a plane that is perpendicular to central axes of the respective cylinders in the cylinder block when the cylinder head 101 is assembled to the cylinder block.

2. Intake Port Central Trajectory Surface (Second Reference Surface)

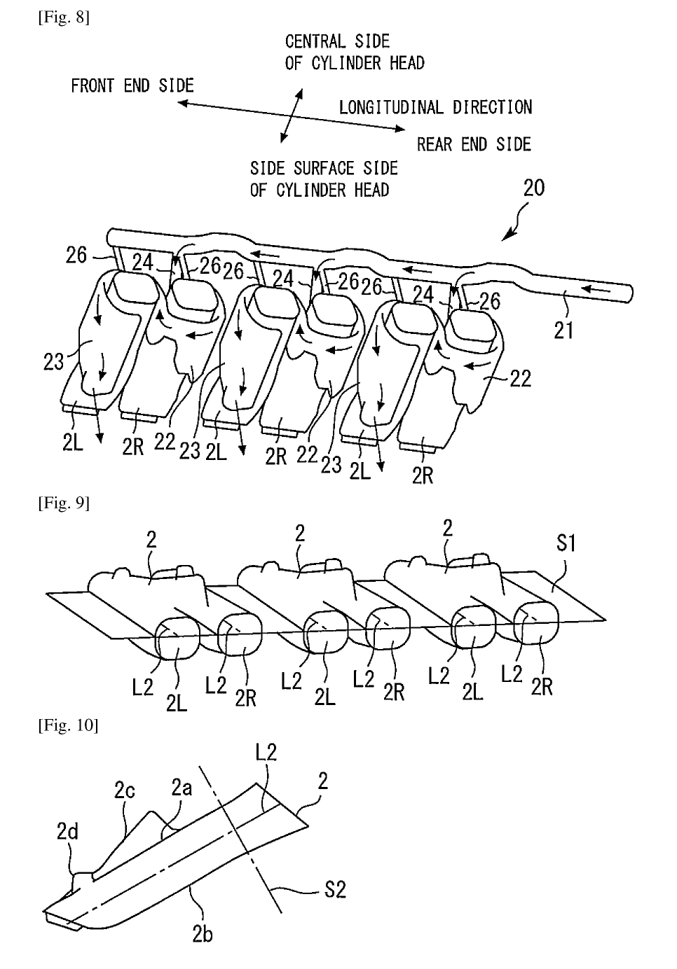

In FIG. 2, FIG. 3 and FIG. 4, virtual lines assigned with reference sign S1 are drawn. The virtual line represents an intake port central trajectory surface that is a second reference surface. The intake port central trajectory surface is a virtual surface that is defined as a surface including central trajectories of the respective intake ports 2. Hereinafter, the central trajectory of the intake port 2 and the intake port central trajectory surface will be described in detail with reference to FIG. 9 to FIG. 13.

FIG. 10 is a side view showing the intake port 2 and a central trajectory L2 thereof of the cylinder head in embodiment 1. A shape of the intake port 2 at the time of seeing the intake port 2 from the front end side of the cylinder head with the inside of the cylinder head made transparent is expressed in FIG. 10. The central trajectory L2 is defined as a line that passes through a center of a section at a time of cutting the intake port 2 perpendicularly to a channel direction thereof. In embodiment 1, the intake port 2 extends substantially straight from an inlet thereof to an intake hole, and therefore, the central trajectory L2 is also expressed by a straight line on a projection surface (a plane perpendicular to the longitudinal direction of the cylinder head). Note that on a top surface 2a of the intake port 2, a port injector mounting portion 2c for mounting the port injector, and an intake valve insertion portion 2d in which the stem of the intake valve is inserted are formed to protrude upward. In calculation of a position of the central trajectory L2, these protruded portions do not have to be taken into consideration.

FIG. 9 is a perspective view of the intake port 2 and the intake port central trajectory surface S1 of the cylinder head in embodiment 1. The shapes of the intake ports 2 at the time of seeing the intake ports 2 with the inside of the cylinder head made transparent, and a positional relation of the respective intake ports 2 and the intake port central trajectory surface S1 are expressed in FIG. 9. From FIG. 9, it is found that the intake port 2 is configured by the two branch ports 2L and 2R. The respective central trajectories L2 become straight lines when they are projected on the plane perpendicular to the longitudinal direction of the cylinder head. Consequently, the intake port central trajectory surface S1 including the respective central trajectories L2 is expressed by a plane that is orthogonal to the plane which is perpendicular to the longitudinal direction of the cylinder head. Of a wall surface that configures the intake port 2, a wall surface which is on a side of the cylinder block mating surface 1a with respect to the intake port central trajectory surface S1 is referred to as an undersurface 2b of the intake port 2, and a wall surface which is on a side opposite from the cylinder block mating surface 1a with respect to the intake port central trajectory surface S1 is referred to as a top surface 2a of the intake port 2.

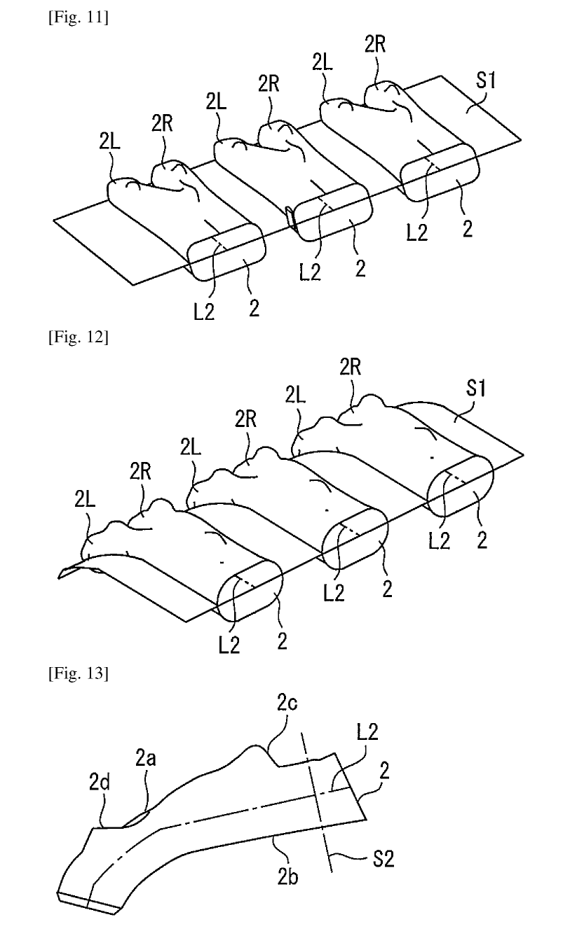

FIG. 11 is a perspective view showing a modification of the intake port 2 and the intake port central trajectory surface S1. Respective parts of the modification are assigned with the same reference signs as those in embodiment 1. In the modification, the intake port 2 has a shape which branches into the two branch ports 2L and 2R halfway. Though not illustrated, the central trajectory L2 also branches into two inside the intake port 2, and each of the branched two central trajectories pass through centers of sections of the branch ports 2L and 2R. The respective central trajectories L2 become straight lines when they are projected on the plane perpendicular to the longitudinal direction of the cylinder head. Consequently, the intake port central trajectory surface S1 including the respective central trajectories L2 is expressed by a plane that is orthogonal to the plane perpendicular to the longitudinal direction of the cylinder head.

FIG. 13 is a side view showing a modification of the intake port 2 and the central trajectory L2 thereof. Respective parts of the modification are assigned with the same reference signs as those in embodiment 1. In the modification, the intake port 2 has a shape that that extends straight from the inlet to a midpoint, and gradually curves downward in the vertical direction toward the inlet hole from the midpoint. Consequently, on a projection surface (the plane perpendicular to the longitudinal direction of the cylinder head), the central trajectory L2 is expressed by a straight line from the inlet of the intake port 2 to the midpoint, and is expressed by a curved line that gradually curves downward in the vertical direction toward the intake hole from the midpoint.

FIG. 12 is a perspective view showing a modification of the intake port 2 and the intake port central trajectory surface S1. From FIG. 12, it is found that the intake port 2 has a straight shape until the intake port 2 branches into the branch ports 2L and 2R at a midpoint, and is curved in the respective branch ports 2L and 2R. The intake port central trajectory surface S1 in this modification is expressed by a plane and a curved surface correspondingly to the shape of the intake port 2. Like this, the intake port central trajectory surface S1 is not always a plane, but may be expressed by a surface in which a plane and a curved surface are combined, or may be expressed by a plurality of curved surfaces with different curvatures, depending on the shape of the intake port 2. This is also applied to the case of the intake port 2 which includes the two branch ports 2L and 2R which independently open to an opening in the right side surface of the cylinder head 101.

3. Reference Point of Intake Port

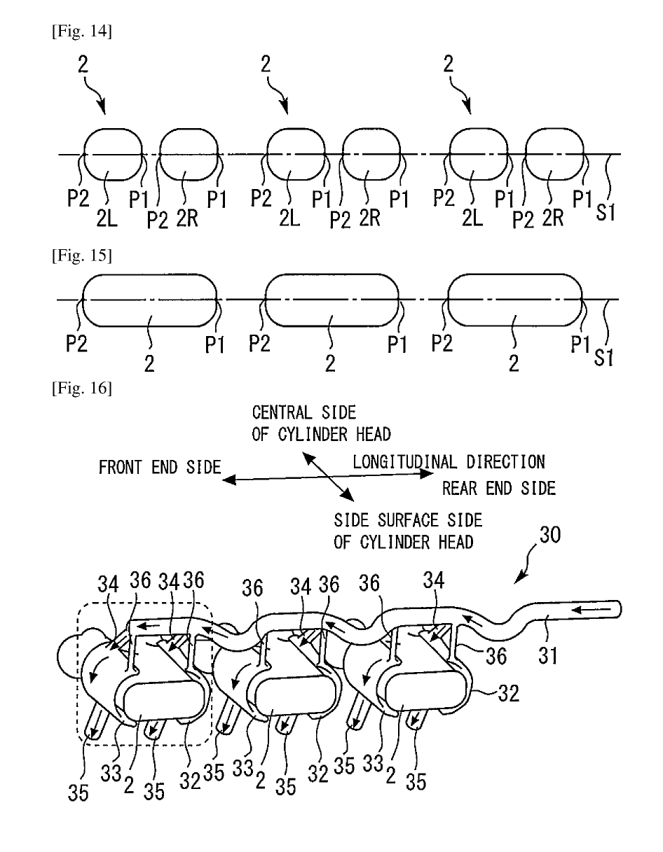

In FIG. 10 and FIG. 13, virtual lines assigned with reference sine S2 are drawn. The virtual lines each expresses a surface perpendicular to the central trajectory L2 of the intake port 2. FIG. 14 is a sectional view of the intake port 2 which is cut at the surface S2 which is perpendicular to the central trajectory of the intake port 2. The intake port 2 shown in FIG. 14 includes the branch ports 2R and 2L as shown in FIG. 9. Out of points at which a wall surface of the branch port 2R and the central trajectory surface S1 intersect each other, one of the points that is located at a rear end side of the cylinder head 101 is expressed as a reference point P1, and the other point which is located at a front end side of the cylinder head 101 is expressed as a reference point P2. Further, out of points at which a wall surface of the branch port 2L and the central trajectory surface S1 intersect each other, a point that is located at the rear end side of the cylinder head 101 is expressed as the reference point P1, and a point that is located at the front end side of the cylinder head 101 is expressed as the reference point P2.

FIG. 15 is a sectional view of the intake port 2 as a modification which is cut at the surface S2 which is perpendicular to the central trajectory of the intake port 2. Respective parts of the modification are assigned with the same reference signs as those in embodiment 1. The intake port 2 in the modification has a shape in which the intake port 2 branches into the two branch ports 2L and 2R halfway as shown in FIG. 11 or FIG. 12. Out of points at which a wall surface of the intake port 2 and the central trajectory surface S1 intersect each other, one of the points that is located at the rear end side of the cylinder head 101 is expressed as the reference point P1, and the other point which is located at the front end side of the cylinder head 101 is expressed as the reference point P2.

### <<Shape of Cooling Water Channel Seen in Perspective Views>>

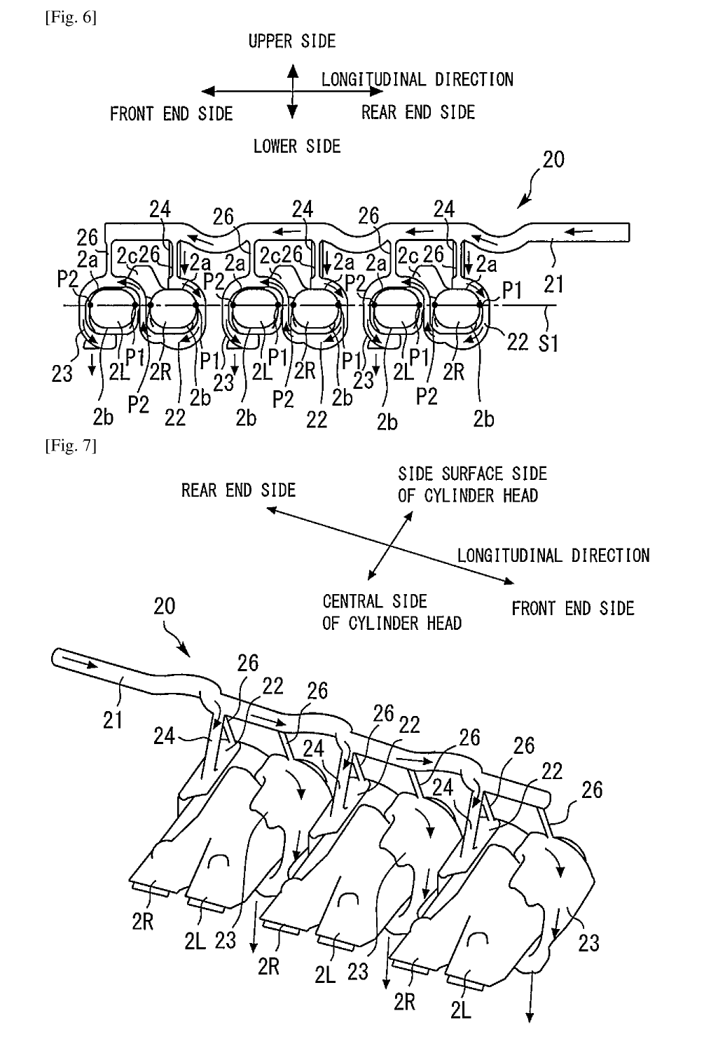

A shape of the cooling water channel that the cylinder head in embodiment 1 has will be described with use of FIG. 5 to FIG. 8. FIG. 5 is a perspective view in which the intake port 2 and a cooling water channel 20 of the cylinder head of embodiment 1 are drawn by being seen through from above the intake side. FIG. 6 is a perspective view in which the intake port 2 and the cooling water channel 20 of the cylinder head of embodiment 1 are drawn by being seen through from a direction along the trajectory central line. FIG. 7 is a perspective view in which the intake port 2 and the cooling water channel 20 of the cylinder head of embodiment 1 are drawn by being seen from above the exhaust side. Further, FIG. 8 is a perspective view in which the intake port 2 and the cooling water channel 20 of the cylinder head of embodiment 1 are drawn by being seen through from below the intake side. In FIG. 5 to FIG. 8, a shape of the cooling water channel 20 at a time of being seen with the inside of the cylinder head made transparent, and a positional relation of the cooling water channel 20 and the intake ports 2 are expressed. Note that the arrows in the drawings express flowing directions of the cooling water.

The cooling water channel 20 is provided in peripheries of the intake ports 2 in the cylinder head. The intake port 2 includes the two branch ports 2L and 2R which are independently opened to the opening in the right side surface of the cylinder head 101. A main channel 21 of the cooling water channel 20 extends on an upper part of a row of the intake ports 2, in a direction of the row of the intake ports 2, that is, in the longitudinal direction of the cylinder head.

The cooling water channel 20 has a unit structure for each of the intake ports 2. In FIG. 5, a structure of a part encircled by a dotted line is the unit structure of the cooling water channel 20. The unit structure includes a water jacket that is placed in peripheries of a pair of the branch ports 2L and 2R which configure the intake port 2. The water jacket is formed of a first water jacket 22 that mainly covers the wall surface in a vicinity of the inlet (a side of the cylinder head side surface) of the branch port 2R, and a second water jacket 23 that mainly covers the wall surface in a vicinity of the inlet (the side of the cylinder head side surface) of the branch port 2L.

The first water jacket 22 is configured to integrally cover a range from the vicinity of a central portion in the longitudinal direction of the top surface 2a to the reference point P2 through the reference point P1, of the wall surface of the branch port 2R, in at least any surface of surfaces that are perpendicular to the central trajectory L2 of the intake port 2. Further, the second water jacket 23 is configured to integrally cover a range from the reference point P1 to a vicinity of the central portion in the longitudinal direction of the undersurface 2b through the top surface 2a and the reference point P2, of the wall surface of the branch port 2L, in at least any surface of the surfaces perpendicular to the central trajectory L2 of the intake port 2. The first water jacket 22 and the second water jacket 23 are integrally connected in a position that is between the branch port 2L and the branch port 2R, and is at the side of the cylinder head side surface from the port injector mounting portion 2c.

In the periphery of the intake port 2 in the cylinder head 101, spaces such as the port injector mounting portion 2c, the intake valve insertion portion 2d, the port injector insertion hole 17 and the cylinder direct injection injector insertion hole 18 are formed. Therefore, the water jacket cannot completely cover the above described ranges in the region in the vicinity of the inlet of the intake port 2. Therefore, the water jacket is formed into a shape that covers the peripheries of the respective intake ports 2 as widely as possible while satisfying constraints in the structure such as escapes from these spaces. According to the water jacket which is configured like this, air that flows in the intake ports 2 can be efficiently cooled. A positional relation between the cooling water channel, and the spaces such as the port injector mounting portion 2c, the intake valve insertion portion 2d, the port injector insertion hole 17 and the cylinder direct injection injector insertion hole 18 will be described in detail later with use of FIG. 2 to FIG. 5.

Of regions of the first water jacket 22 that cover the top surface 2a of each of the branch ports 2R, a region in a vicinity of the end portion at the upper side and the cylinder head central side is connected to the main channel 21 via a branch channel 24. Further, of regions of the second water jacket 23 which covers the undersurface 2b of each of the branch ports 2L, a region in a vicinity of the end portion at a lower side and at the cylinder head central side is opened to the cylinder block mating surface 1a via a connection path 25 (not illustrated in FIG. 5 to FIG. 8). One end of the main channel 21 is opened to the rear end surface 1d of the cylinder head, and the other end is closed inside the cylinder head. A channel at the cooling water introduction side, of the circulation system is connected to an opening portion of the main channel 21, and an opening of the connection path 25 which is provided in the cylinder block mating surface 1a communicates with a cooling water channel inlet that is provided in the cylinder head mating surface of the cylinder block.

According to the configuration like this, cooling water that is cooled in the radiator is introduced into the main channel 21. The cooling water which is introduced into the main channel 21 is guided in parallel to the water jackets of the respective intake ports 2 via the branch channels 24 respectively. In the water jacket of each of the intake ports 2, the cooling water which is guided from the upper side of the first water jacket 22 sequentially flows inside the first water jacket 22 and the second water jacket 23, and flows to the cooling water channel in the cylinder block from the end portion at the lower side of the second water jacket 23.

The water jacket is provided with auxiliary channels 26 that communicate with the main channel 21. The auxiliary channels 26 are channels that are also used as air bleeders, and are each provided from top portions in the vertical direction of the first water jacket 22 and the second water jacket 23 toward the main channel 21. Note that the auxiliary channel 26 is configured as a channel that has a channel sectional area smaller than that of the branch channel 24.

According to the above described configuration shown in FIG. 5 to FIG. 8, the water jackets of the respective intake ports 2 are configured independently, and therefore, the cooling water which receives heat by flowing in the periphery of each of the intake ports 2 does not flow into the peripheries of the other intake ports 2. Consequently, the peripheries of the respective intake ports 2 can be equally cooled, and therefore, variation in the intake temperatures among the intake ports can be restrained.

Next, a configuration of the cooling water channel in the cylinder head, in particular, a positional relation of the cooling water channel and other components of the cylinder head will be described with reference to the sectional view.

### <<Configuration of Cooling Water Channel of Cylinder Head Seen in Section That Includes Central Axis of Intake Valve Insertion Hole and is Perpendicular to Longitudinal Direction of Cylinder Head>>

In FIG. 2, a sectional shape of the cooling water channel in the section which includes the central axis of the intake valve insertion hole 7 and is perpendicular to the longitudinal direction of the cylinder head 101 is drawn. Further, FIG. 2 shows the positional relation of the cooling water channel and the components of the cylinder head 101.

In the section shown in FIG. 2, in a region in the vicinity of the inlet of the intake port 2, the first water jacket 22 is disposed along the top surface 2a and the undersurface 2b of the intake port 2. Further, in a region that is adjacent to the intake side valve mechanism chamber 5 and in a vicinity of the side of the cylinder head side surface, the main channel 21 of the cooling water channel 20 is disposed. Further, the branch channel 24 is disposed to connect to the first water jacket 22 along the intake side valve mechanism chamber 5 from the main channel 21. Further, the auxiliary channel 26 is configured as the channel having the channel section smaller than the branch channel 24, and is disposed to connect to the main channel 21 from the top portion in the vertical direction of the first water jacket 22.

According to the above described configuration shown in FIG. 2, the main channel 21 is disposed in the upper portion of the row of the intake ports 2, and therefore, heat reception by the cooling water in the main channel 21 from the cylinder block mating surface 1a is restrained. Consequently, low-temperature cooling water can be introduced into the water jackets of the respective intake ports 2 from the main channel 21.

Further, according to the above described configuration shown in FIG. 2, the branch channel 24 is configured to be connected to the first water jacket 22 at an acute angle, in order to decrease channel resistance at a time of the cooling water being introduced into the first water jacket 22. Consequently, air accumulations are made in a region vertically above the a communication portion of the first water jacket 22 with the branch channel 24, and are likely to inhibit flow of the cooling water. In this regard, the auxiliary channel 26 communicates with the top portion in the vertical direction of the first water jacket 22, and therefore, the air in the first water jacket 22 can be caused to escape to the main channel 21 via the auxiliary channel 26. Further, the auxiliary channels 26 which are provided at the second water jackets 23 shown in FIG. 5 to FIG. 8 can also cause the air in the second water jackets 23 to escape to the main channel 21 via the auxiliary channels 26 in the same way.

If the channel sectional area of the auxiliary channel 26 is made equivalent to the branch channel 24, the cooling water is introduced into the water jacket from a plurality of positions, whereby the cooling water is likely to stagnate in the water jacket without efficiently flows therein. In this regard, the auxiliary channel 26 is configured as the channel having the channel section smaller than the branch channel 24, and therefore, the cooling water can be caused flow efficiently in the water jacket by restraining introduction of the cooling water from the auxiliary channel 26.

### <<Configuration of Cooling Water Channel of Cylinder Head Seen in Section That Includes Central Axis of Combustion Chamber and is Perpendicular to Longitudinal Direction>>

In FIG. 3, a sectional shape of the cooling water channel in the section that includes the central axis L1 of the combustion chamber 4 and is vertical to the longitudinal direction of the cylinder head 101 is drawn. Further, FIG. 3 shows the positional relation of the cooling water channel and the components of the cylinder head 101.

In the section shown in FIG. 3, the first water jacket 22 and the second water jacket 23 are integrally disposed in the vicinity of the inlet of the intake port 2. The first water jacket 22 extends to a position with a predetermined wall thickness left with respect to the cylinder direct injection injector insertion hole 18, toward the lower side of the central trajectory surface S1. Further, the second water jacket 23 extends to a position with predetermined wall thicknesses left with respect to the port injector mounting portion 2c and the port injector insertion hole 17, toward the upper side of the central trajectory surface S1. Further, in a region that is adjacent to the intake side valve mechanism chamber 5 and is in a vicinity of the side of the cylinder head side surface, the main channel 21 of the cooling water channel 20 is disposed.

According to the above described configuration shown in FIG. 3, the first water jacket 22 and the second water jacket 23 can cover the wall surface of the intake port 2 in the wide range while avoiding the port injector mounting portion 2c, the port injector insertion hole 17 and the cylinder direct injection injector insertion hole 18. Further, according to the above described configuration shown in FIG. 3, the first water jacket 22 can be connected to the second water jacket 23 through a space between the branch port 2R and the branch port 2L, and therefore, the peripheries of the branch port 2R and the branch port 2L can be efficiently covered.

### <<Configuration of Cooling Water Channel of Cylinder Head Seen in Section That Passes Through Space Between Two Adjacent Combustion Chambers and is Perpendicular to Longitudinal Direction>>

In FIG. 4, a sectional shape of the cooling water channel in the section that passes through a space between two adjacent combustion chambers and is perpendicular to the longitudinal direction of the cylinder head 101 is drawn. Further, FIG. 4 shows a positional relation of the cooling water channel and the components of the cylinder head 101.

In the section shown in FIG. 4, a part of the connection path 25 of the cooling water channel which connects the water jacket and the cooling water channel of the cylinder block is located, in a region that faces the cylinder head mating surface 1a, and is nearer to a center of the cylinder head 101 than the head bolt insertion hole 13 at the intake side. Further, the main channel 21 of the cooling water channel 20 is disposed in a region that is adjacent to the intake side valve mechanism chamber 5 and is in a vicinity of the side of the cylinder head side surface. According to the above described configuration shown in FIG. 4, the cooling water which flows in the water jacket can be efficiently guided to the cooling water channel of the cylinder block.

As described above, according to the cooling water channel of embodiment 1 of the present invention, even in the engine which is equipped with the port injectors and the cylinder direct injection injectors, the wall surfaces of the respective intake ports 2 can be cooled in the wide ranges. Further, since the cooling water can be introduced from the main channel 21 in parallel to the water jackets of the respective intake ports 2, variation in the intake temperatures among the intake ports can be restrained.

In the cylinder head of embodiment 1 of the present invention described above, the first water jacket 22 is configured to integrally cover the range from the vicinity of the central portion in the longitudinal direction of the top surface 2a to the reference point P2 through the reference point P1, of the wall surface of the branch port 2R, in at least any surface of the surfaces which are perpendicular to the central trajectory L2 of the intake port 2. However, the range of the wall surface of the branch port 2R which is covered with the first water jacket 22 is not limited to the range to the vicinity of the central portion in the longitudinal direction of the top surface 2a, but at least the range of the undersurface 2b can be covered. Similarly, the range of the branch port 2L which is covered with the second water jacket 23 is not limited to the range to the vicinity of the central portion in the longitudinal direction of the undersurface 2b, but at least the range of the top surface 2a can be covered.

Further, in the cylinder head of embodiment 1 described above, the sectional shape of the intake port 2 which is cut perpendicularly to the channel direction thereof is not limited. That is to say, the sectional shape of the intake port 2 may be perfectly circular, or may be elliptic or oval, as long as the branch ports 2R and 2L which configure the intake port 2 are independently opened to the inlet side respectively.

Further, in the cylinder head of embodiment 1, the configuration of the cooling water channel which is suitable for the case where the port injector mounting portion 2c, the port injector insertion hole 17 and the cylinder direct injection injector insertion hole 18 are formed in the periphery of the intake port 2 is described, but the configuration of the cooling water channel 20 of embodiment 1 may be applied in the cylinder head in which these spaces are not formed.

Further, in the cylinder head of embodiment 1 described above, the configuration is adopted, in which the branch channel 24 is connected to the end portion at the upper side and the cylinder head central side, of the region of the first water jacket 22 which covers the top surface 2a of each of the branch ports 2R, but the branch channel 24 does not have to be connected to the end portion, and can be connected to another portion as long as it is in the region of the first water jacket 22 which covers the top surface 2a of each of the branch ports 2R. Further, in the cylinder head of embodiment 1 described above, the connection path 25 is connected to the end portion at the lower side and the cylinder head central side, of the region of the second water jacket 23 which covers the undersurface 2b of each of the branch ports 2L, but the connection path 25 does not have to be connected to the end portion, and can be connected to another portion as long as it is in the region of the second water jacket 23 which covers the undersurface 2b of each of the branch ports 2L.

In the cylinder head of embodiment 1 described above, the water jacket corresponds to an “intake port cooling water jacket” in the first invention, the second reference surface S1 corresponds to a “central trajectory surface” in the first invention, the main channel 21 corresponds to a “cooling water supplying main channel” in the first invention, and the branch channel 24 corresponds to a “cooling water supplying branch channel” in the first invention. Further, in the cylinder head of embodiment 1 described above, the branch port 2R corresponds to a “first branch port” in the second invention, and the branch port 2L corresponds to a “second branch port” in the second invention. Further, in the cylinder head of embodiment 1 described above, the connection path 25 corresponds to a “cooling water discharging channel” in the third invention. Further, in the cylinder head of embodiment 1 described above, the auxiliary channel 26 corresponds to an “auxiliary channel” in the fourth or the fifth invention.

### Embodiment 2

Next, embodiment 2 of the present invention will be described with use of the drawings. A cylinder head in embodiment 2 is the same as the cylinder head in embodiment 1 in regard with a basic configuration thereof, except for a shape of an intake port. The intake port 2 in embodiment 2 is of a configuration in which the intake port having a single opening branches into the two branch ports 2L and 2R halfway, as shown in FIG. 11 or FIG. 12, for example. In the intake port 2, a sectional shape at a time of being cut perpendicularly to a central trajectory is formed into an elliptic shape which extends along the longitudinal direction of the cylinder head, at the side of the cylinder head side surface from a position where the intake port 2 branches into the two branch ports 2L and 2R. However, the sectional shape of the intake port 2 is not limited to this, and may be formed into another shape such as a perfect circle or an oval.

With respect to the other basic configuration of the cylinder head of embodiment 2, explanation of the basic configuration of the cylinder head of embodiment 1 is directly cited, and redundant explanation is not performed here. Hereinafter, a configuration of the cooling water channel of the cylinder head of embodiment 2 will be described. Explanation is made with use of perspective views in which the cooling water channel inside the cylinder head is drawn by being seen through. Further, in the respective drawings, the elements which are common to those in embodiment 1 are assigned with the same reference signs.

### <Configuration of Cooling Water Channel of Cylinder Head of Embodiment 2>

### <<Shape of Cooling Water Channel Seen in Perspective Views>>

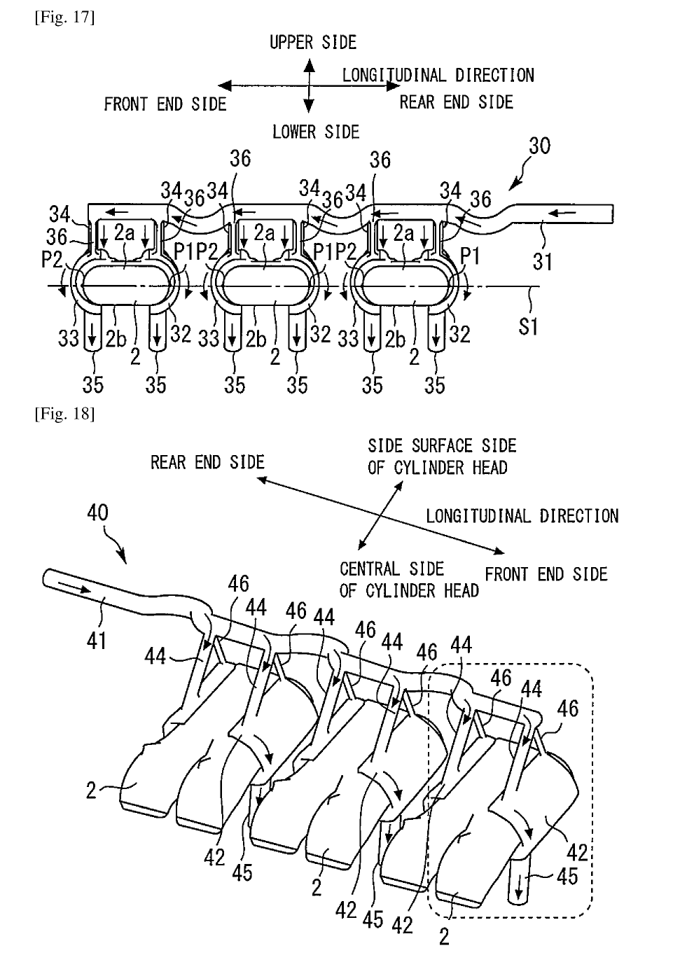

A shape of the cooling water channel that the cylinder head in embodiment 2 has will be described with use of FIG. 16 and FIG. 17. FIG. 16 is a perspective view in which the intake port 2 and a cooling water channel 30 of the cylinder head of embodiment 2 are drawn by being seen through from above the intake side. FIG. 17 is a perspective view in which the intake port 2 and the cooling water channel 30 of the cylinder head of embodiment 2 are drawn by being seen through from a direction along the trajectory central line. In FIG. 16 and FIG. 17, a shape of the cooling water channel 30 at a time of being seen with the inside of the cylinder head made transparent, and a positional relation of the cooling water channel 30 and the intake ports 2 are expressed. Note that the arrows in the drawings express flowing directions of cooling water.

The cooling water channel 30 is provided in peripheries of the intake ports 2 in the cylinder head. A main channel 31 of the cooling water channel 30 extends on an upper part of a row of the intake ports 2, in a direction of the row of the intake ports 2, that is, in the longitudinal direction of the cylinder head.

The cooling water channel 30 has a unit structure for each of the intake ports 2. In FIG. 16, a structure of a part surrounded by a dotted line is the unit structure of the cooling water channel 30. The unit structure includes a water jacket that is placed in a periphery of the intake port 2. The water jacket is formed of a first water jacket 32 that mainly covers a wall surface at a rear end side in the longitudinal direction, and a second water jacket 33 that mainly covers a wall surface at a front end side in the longitudinal direction, of the wall surface at the side of the cylinder head side surface from the position where the intake port 2 branches into the branch ports 2R and 2L. The first water jacket 32 is configured to integrally cover a side surface that includes the reference point 1 and is mainly formed of a curved surface, of the wall surface of the intake port 2, in at least any surface of surfaces perpendicular to the central trajectory L2 of the intake port 2. Further, the second water jacket 33 is configured to integrally cover a side surface that includes the reference point P2 and is mainly formed of a curved surface, of the wall surface of the intake port, in at least any surface of the surfaces perpendicular to the central trajectory L2 of the intake port 2.

Note that the first water jacket 32 and the second water jacket 33 of each of the intake ports 2 are each configured independently with consideration given to wall thicknesses corresponding to amounts of escapes from spaces such as the port injector mounting portion 2c, the intake valve insertion portion 2d, the port injector insertion hole 17 and the cylinder direct injection injector insertion hole 18. That is to say, the water jacket of embodiment 2 is formed into a shape that is divided in a region at a central portion in the longitudinal direction of the top surface 2a of the intake port and a region at a central portion in the longitudinal direction of the undersurface 2b.

According to the water jacket which is configured like this, even when the spaces such as the port injector mounting portion 2c, the intake valve insertion portion 2d, the port injector insertion hole 17 and the cylinder direct injection injector insertion hole 18 are formed in the periphery of the intake port 2 in the cylinder head, the water jackets of the cooling water channel 30 in embodiment 2 can widely cover the peripheries of the respective intake ports 2 while satisfying constraints in the structure such as the escapes from these spaces.

In regions of the first water jackets 32 and the second water jackets 33 that cover the top surfaces 2a of the respective intake ports 2, the end portions at the upper side and the cylinder head central side are each connected to the main channel 31 via branch channels 34. Further, in regions of the first water jackets 32 and the second water jackets 33 which cover the undersurfaces 2b of the respective intake ports 2, end portions at the lower side and at the cylinder head central side are opened to the cylinder block mating surface 1a via connection paths 35. One end of the main channel 31 is opened to the rear end surface 1d of the cylinder head, and the other end is closed inside the cylinder head. A channel at the cooling water introduction side, of the circulation system is connected to the opening portion of the main channel 31, and the connection path 35 which is opened to the cylinder block mating surface 1a communicates with the cooling water channel inlet which is provided in the cylinder head mating surface of the cylinder block. According to the configuration like this, cooling water that is cooled in the radiator is introduced into the main channel 31. The cooling water which is introduced into the main channel 31 is guided in parallel to the respective water jackets of each of the intake ports 2 via the branch channels 34. In the water jacket of each of the intake ports 2, the cooling water is guided to the first water jacket 32 and the second water jacket 33 via the separate branch channels 34. The introduced cooling water flows inside the first water jacket 32 and the second water jacket 33, and flows to the cooling water channel in the cylinder block from the respective end portions at lower sides of the first water jacket 32 and the second water jacket 33 via the separate connection paths 35.

The water jacket is provided with auxiliary channels 36 that communicate with the main channel 31. The auxiliary channels 36 are channels that are also used as air bleeders, and are each provided at top portions in the vertical direction of the first water jacket 32 and the second water jacket 33 to the main channel 31. Note that the auxiliary channel 36 is configured as a channel that has a channel sectional area smaller than that of the branch channel 34.

According to the above described configuration shown in FIG. 16 to FIG. 17, the water jackets of the respective intake ports 2 are configured independently, and therefore, the cooling water which receives heat by flowing in the periphery of each of the intake ports 2 does not flow into the peripheries of the other intake ports 2. Consequently, the peripheries of the respective intake ports 2 can be equally cooled, and therefore, variation in the intake air temperatures among the intake ports can be restrained. In particular, in the water jacket in the cooling water channel 30, the cooling water that flows in the main channel 31 is introduced in parallel via the branch channels 34 which are each connected to the first water jacket 32 and the second water jacket 33 of each of the intake ports 2, and therefore, variation in the cooling effect can be restrained by introducing the cooling water with an equal temperature into each of the first water jacket 32 and the second water jacket 33. Further, the main channel 31 is disposed at the upper part of the row of the intake ports 2, and therefore, heat reception by the cooling water in the main channel 31 from the cylinder block mating surface 1a is restrained. Consequently, the low-temperature cooling water can be introduced into the water jackets of the respective intake ports 2 from the main channel 31.

Further, according to the above described configuration shown in FIG. 16 and FIG. 17, the auxiliary channels 36 communicate with the top portions in the vertical direction of the first water jacket 32 and the second water jacket 33, and therefore, the air in the first water jacket 32 and the second water jacket 33 can be caused to escape to the main channel 31 via the auxiliary channels 36. Further, the auxiliary channel 36 is configured as the channel having the channel section smaller than the branch channel 34, and therefore, the cooling water can be caused flow efficiently into the water jacket by restraining introduction of the cooling water from the auxiliary channel 36.

Incidentally, in the cylinder head of embodiment 2 described above, the first water jacket 32 is configured to integrally cover the side surface which includes the reference point P1 and is mainly configured by the curved surface, of the wall surface of the intake port 2, in at least any surface of the surfaces which are perpendicular to the central trajectory L2 of the intake port 2. However, the range of the wall surface of the intake port 2 which is covered with the first water jacket 32 is not limited to the above described range, but can be a range of the wall surface that includes at least the reference point P1. Similarly, the range of the wall surface of the intake port 2 which is covered with the second water jacket 33 can be a range of the wall surface which includes at least the reference point P2.

Further, in the cylinder head of embodiment 2 described above, the configuration of the cooling water channel which is suitable for the case where the port injector mounting portion 2c, the port injector insertion hole 17 and the cylinder direct injection injector insertion hole 18 are formed in the periphery of the intake port 2 is described, but the configuration of the cooling water channel 30 of embodiment 2 may be applied in the cylinder head in which these spaces are not formed.

Further, in the cylinder head of embodiment 2 described above, the branch channels 34 are connected to the end portions at the upper side and the cylinder head central side, of the regions of the first water jackets 32 and the second water jackets 33 which cover the top surfaces 2a of the respective intake ports 2, but the branch channels 34 do not have to be connected to the end portions, and can be connected to other portions as long as they are in the regions of the first water jackets 32 and the second water jackets 33 which cover the top surfaces 2a of the respective intake ports 2. Further, in the cylinder head of embodiment 2 described above, the connection paths 35 are connected to the end portions at the lower side and the cylinder head central side, of the regions of the first water jackets 32 and the second water jacket 33 which cover the undersurfaces 2b of the respective intake ports 2, but the connection paths 35 do not have to be connected to the end portions, and can be connected to other portions as long as they are in the regions of the first water jackets 32 and the second water jackets 33 which cover the undersurfaces 2b of the respective intake ports 2.

In the cylinder head of embodiment 2 described above, the water jacket corresponds to the “intake port cooling water jacket” in the first invention, the second reference surface S1 corresponds to the “central trajectory surface” in the first invention, the main channel 31 corresponds to the “cooling water supplying main channel” in the first invention, and the branch channel 34 corresponds to the “cooling water supplying branch channel” in the first invention. Further, in the cylinder head of embodiment 2 described above, the reference point P1 corresponds to a “first position” in the seventh invention, the reference point P2 corresponds to a “second position” in the seventh invention, the first water jacket 32 corresponds to a “first side surface water jacket” in the seventh invention, and the second water jacket 33 corresponds to a “second side surface water jacket” in the seventh invention. Further, in the cylinder head of embodiment 2 described above, the connection path 35 corresponds to the “cooling water discharging channel” in the first invention. Further, in the cylinder head of embodiment 2 described above, the auxiliary channel 36 corresponds to an “auxiliary channel” in the twelfth invention.

### Embodiment 3

Next, embodiment 3 of the present invention will be described with use of the drawings. A cylinder head in embodiment 3 is the same as the cylinder head in embodiment 1 concerning a basic configuration thereof, except for a shape of an intake port, and the point that the cylinder direct injection injector insertion hole 18 is not formed. The intake port 2 in embodiment 3 is of a configuration in which the intake port which has a single opening branches into the two branch ports 2L and 2R halfway, as shown in FIG. 11 or FIG. 12, for example. In the intake port 2, a sectional shape at a time of being cut perpendicularly to a central trajectory is formed into an elliptic shape which extends along the longitudinal direction of the cylinder head, at the side of the cylinder head side surface from a position where the intake port 2 branches into the two branch ports 2L and 2R. However, the sectional shape of the intake port 2 is not limited to this, and may be formed into another shape such as a perfect circle or an oval.

With respect to the other basic configuration of the cylinder head of embodiment 3, the explanation of the basic configuration of the cylinder head of embodiment 1 is directly cited, and redundant explanation is not made here. Hereinafter, a configuration of the cooling water channel of the cylinder head of embodiment 3 will be described. Explanation is made with use of perspective views in which the cooling water channel inside the cylinder head is drawn by being seen through. Further, in the respective drawings, the elements common to those in embodiment 1 are assigned with the same reference signs.

### <Configuration of Cooling Water Channel of Cylinder Head of Embodiment 3>

### <<Shape of Cooling Water Channel Seen in Perspective Views>>

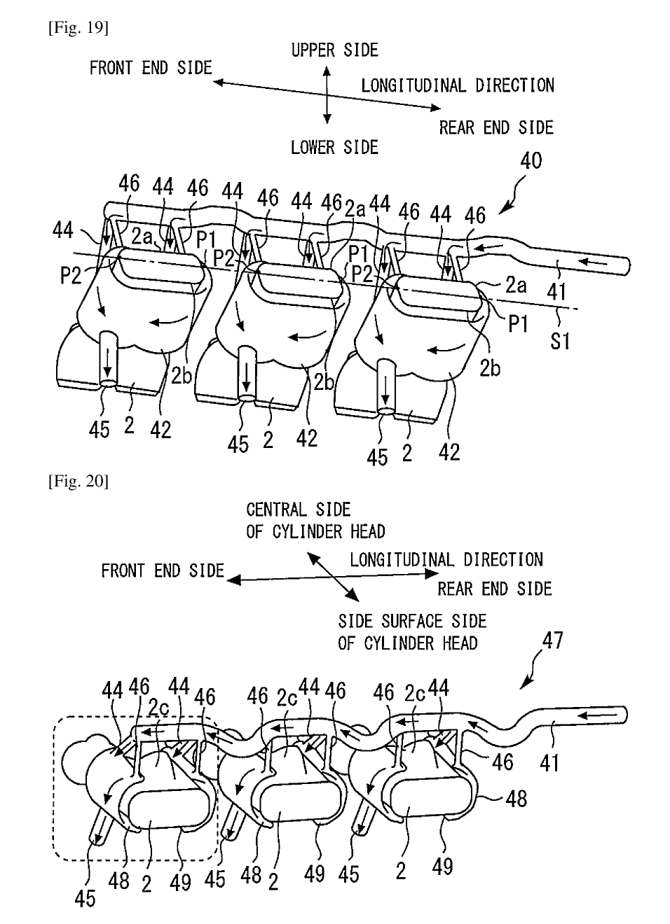

A shape of the cooling water channel that the cylinder head in embodiment 3 has will be described with use of FIG. 18 and FIG. 19. FIG. 18 is a perspective view in which the intake port 2 and a cooling water channel 40 of the cylinder head of embodiment 3 are drawn by being seen through from above the exhaust side. FIG. 19 is a perspective view in which the intake port 2 and the cooling water channel 40 of the cylinder head of embodiment 3 are drawn by being seen through from below the intake side. In FIG. 18 and FIG. 19, a shape of the cooling water channel 40 at a time of being seen with the inside of the cylinder head being made transparent, and a positional relation of the cooling water channel 40 and the intake ports 2 are expressed. Note that the arrows in the drawings express flowing directions of the cooling water.

The cooling water channel 40 is provided in peripheries of the intake ports 2 in the cylinder head. A main channel 41 of the cooling water channel 40 extends on an upper part of a row of the intake ports 2, in a direction of the row of the intake ports 2, that is, in the longitudinal direction of the cylinder head.

The cooling water channel 40 has a unit structure for each of the intake ports 2. In FIG. 18, a structure of a part which is encircled by a dotted line is the unit structure of the cooling water channel 40. The unit structure includes a water jacket 42 that is placed in a periphery of the intake port 2. The water jacket 42 is configured to integrally cover a range that includes a side surface that includes the reference point P1 and is mainly configured by a curved surface, a side surface that includes the reference point P2 and is mainly configured by a curved surface, and the undersurface 2b of the intake port 2, of a wall surface of the intake port 2, in at least any surface of surfaces that are perpendicular to the central trajectory L2 of the intake port 2. Note that the water jacket 42 of each of the intake ports 2 is formed into a shape that is divided in a region at a central portion in the longitudinal direction of the top surface 2a of the intake port, in order to ensure wall thicknesses corresponding to amounts of escapes from spaces such as the port injector mounting portion 2c, the intake valve insertion portion 2d, and the port injector insertion hole 17.

According to the water jacket 42 which is configured as above, even when the spaces such as the port injector mounting portion 2c, the intake valve insertion portion 2d, and the port injector insertion hole 17 are formed in the periphery of the intake port 2 in the cylinder head, the water jackets 42 of the cooling water channel 40 in embodiment 3 can widely cover the peripheries of the respective intake ports 2 while satisfying constraints in the structure such as the escapes from these spaces. Further, the water jacket 42 has the structure that covers the undersurface 2b side of the intake port 2, and therefore, heat reception by the air which flows in the intake port 2 from the top surface of the combustion chamber which has a high temperature can be effectively restrained in the wide range.

In two regions of each of the water jackets 42 that cover the top surfaces 2a of the respective intake ports 2, respective end portions that are located at the upper side and the cylinder head central side are connected to the main channel 41 via branch channels 44. Further, in a region of each of the water jackets 42 which cover the undersurfaces 2b of the respective intake ports 2, a location at the front end side and the central side of the cylinder head is opened to the cylinder block mating surface 1a via a connection path 45. One end of the main channel 41 is opened to the rear end surface 1d of the cylinder head, and the other end is closed inside the cylinder head. A channel at the cooling water introduction side, of the circulation system is connected to an opening portion of the main channel 41, and the connection path 45 which is opened to the cylinder block mating surface 1a communicates with the cooling water channel inlet which is provided in the cylinder head mating surface of the cylinder block. According to the configuration like this, cooling water that is cooled in the radiator is introduced into the main channel 41. The cooling water which is introduced into the main channel 41 is guided in parallel to the water jackets 42 of the respective intake ports 2 via the branch channels 44. In the water jacket 42 of each of the intake ports 2, the cooling water is guided to both sides of an upper side of the water jacket 42 via the two branch channels 44. The introduced cooling water flows inside the water jacket 42, and flows to the cooling water channel in the cylinder block via the connection path 45 from the lower side of the water jacket 42.

The water jacket 42 is provided with two auxiliary channels 46 that communicate with the main channel 41. The auxiliary channels 46 are channels that are also used as air bleeders, and are each provided at top portions in the vertical direction of the upper side of the water jacket 42 to the main channel 41. Note that the auxiliary channel 46 is configured as a channel that has a channel sectional area smaller than that of the branch channel 44.

According to the above described configuration shown in FIG. 18 and FIG. 19, the water jackets 42 of the respective intake ports 2 are configured independently, and therefore, the cooling water which receives heat by flowing in the periphery of each of the intake ports 2 does not flow into the peripheries of the other intake ports 2. Consequently, the peripheries of the respective intake ports 2 can be equally cooled, and therefore, variation in the intake air temperatures among the intake ports can be restrained. In particular, in the water jacket 42 in the cooling water channel 40, the cooling water that flows in the main channel 41 is introduced via the respective branch channels 44 which are connected to both ends of the upper side of the water jacket 42 of each of the intake ports 2, and therefore, variation in the cooling effect can be restrained by introducing the cooling water with an equal temperature from both sides of the water jacket 42. Further, the main channel 41 is disposed in the upper part of the row of the intake ports 2, and therefore, heat reception by the cooling water in the main channel 41 from the cylinder block mating surface 1a is restrained. Consequently, the low-temperature cooling water can be introduced into the water jackets of the respective intake ports 2 from the main channel 41.

Further, according to the above described configuration shown in FIG. 18 and FIG. 19, the auxiliary channels 46 each communicate with the top portions in the vertical direction at both the ends of the upper side of the water jacket 42, and therefore, the air in the water jacket 42 can be caused to escape to the main channel 41 via the auxiliary channels 46. Further, the auxiliary channel 46 is configured as the channel having the channel section smaller than that of the branch channel 44, and therefore, the cooling water can be caused to flow efficiently into the water jacket 42 by restraining introduction of the cooling water from the auxiliary channels 46.

Incidentally, in the cylinder head of embodiment 3 of the present invention described above, the water jacket 42 is configured to integrally cover the range which includes the side surface which includes the reference point P1 and is mainly configured by the curved surface, the side surface which includes the reference point P2 and is mainly configured by the curved surface, and the undersurface 2b of the intake port 2 of the wall surface of the intake port 2, in at least any surface of the surfaces perpendicular to the central trajectory L2 of the intake port 2. However, the range of the wall surface of the intake port 2 which is covered with the water jacket 42 is not limited to the above described range, and at least the range of the undersurface 2b from the reference point P1 to the reference point P2 can be covered.

Further, in the cylinder head of embodiment 3 described above, the configuration is adopted, which connects the branch channels 44 to the respective end portions which are located at the upper side and the cylinder head central side, in the two regions of each of the water jackets 42 which cover the top surfaces 2a of the respective intake ports 2, but the branch channels 44 do not have to be connected to the end portions, and can be connected to other portions as long as they are in the region of each of the water jackets 42 which cover the top surfaces 2a of the respective intake ports 2. Further, in the cylinder head of embodiment 3 described above, the configuration is adopted, which connects the connection path 45 to the position at the front end side and the cylinder head central side, in the region of each of the water jackets 42 which cover the undersurfaces 2b of the respective intake ports 2, but disposition of the connection paths 45 is not specially limited as long as it is in the regions of the water jackets 42 which cover the undersurfaces 2b of the respective intake ports 2.

In the cylinder head of embodiment 3 described above, the water jacket 42 corresponds to the “intake port cooling water jacket” in the first invention, the second reference surface S1 corresponds to the “central trajectory surface” in the first invention, the main channel 41 corresponds to the “cooling water supplying main channel” in the first invention, and the branch channel 44 corresponds to the “cooling water supplying branch channel” in the first invention. Further, in the cylinder head of embodiment 3 described above, the connection path 45 corresponds to the “cooling water discharging channel” in the fourteenth invention. Further, in the cylinder head of embodiment 3 described above, the auxiliary channel 46 corresponds to an “auxiliary channel” in the fifteenth invention.

### Embodiment 4

Next, embodiment 4 of the present invention will be described with use of the drawings. The cylinder head in embodiment 4 is one modification of the cylinder head of embodiment 3. The cylinder head in embodiment 4 differs from the cylinder head in embodiment 3 in the configuration of the cooling water channel, and the point that the cylinder head in embodiment 4 has the cylinder direct injection injector insertion hole 18. Hereinafter, a configuration of the cooling water channel of the cylinder head of embodiment 4 will be described. Explanation is made with use of perspective views in which the cooling water channel inside the cylinder head is drawn by being seen through. Further, in the respective drawings, the elements common to those in embodiment 3 are assigned with the same reference signs.

### <Configuration of Cooling Water Channel of Cylinder Head of Embodiment 4>

### <<Shape of Cooling Water Channel Seen in Perspective Views>>

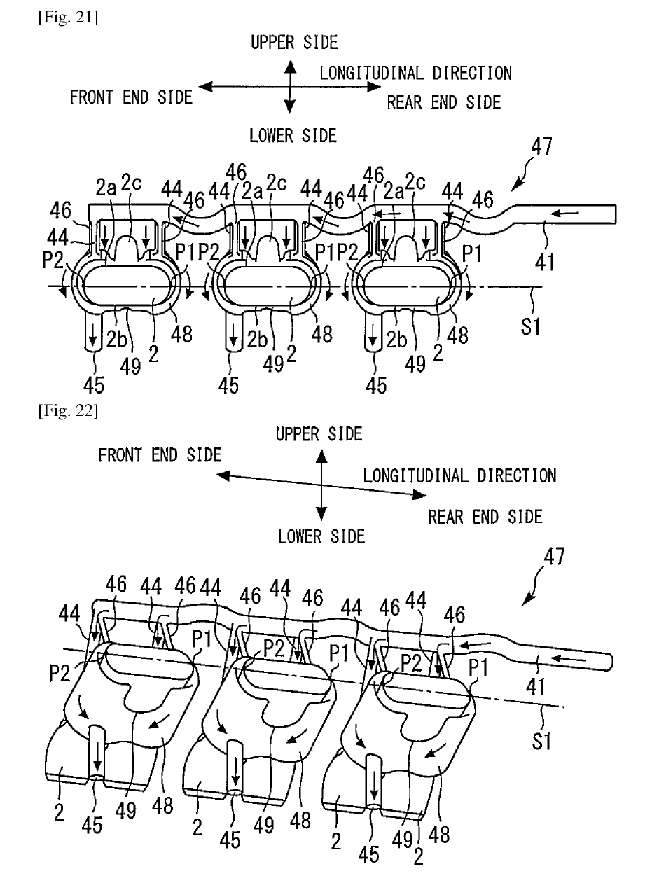

A shape of the cooling water channel that the cylinder head in embodiment 4 has will be described with use of FIG. 20 to FIG. 22. FIG. 20 is a perspective view in which the intake port 2 and a cooling water channel 47 of the cylinder head of embodiment 4 are drawn by being seen through from above an intake side. FIG. 21 is a perspective view in which the intake port 2 and the cooling water channel 47 of the cylinder head of embodiment 4 are drawn by being seen through from a direction along a trajectory central line. Further, FIG. 22 is a perspective view in which the intake port 2 and the cooling water channel 47 of the cylinder head in embodiment 4 are drawn by being seen through from below the intake side. In FIG. 20 to FIG. 22, a shape of the cooling water channel 47 at a time of being seen with the inside of the cylinder head made transparent, and a positional relation of the cooling water channel 47 and the intake ports 2 are expressed. Note that the arrows in the drawings express flowing directions of the cooling water.

The cooling water channel 47 has a unit structure for each of the intake ports 2. In FIG. 20, a structure of a part encircled by a dotted line is the unit structure of the cooling water channel 47. The unit structure includes a water jacket 48 that is placed in a periphery of the intake port 2. The water jacket 48 is configured to integrally cover a range that includes a side surface that includes the reference point P1 and is mainly configured by a curved surface, a side surface that includes the reference point P2 and is mainly configured by a curved surface, and the undersurface 2b of the intake port 2, of a wall surface of the intake port 2, in at least any surface of surfaces perpendicular to the central trajectory L2 of the intake port 2. Note that the water jacket 48 of each of the intake ports 2 is formed into a shape that is divided in a region at a central portion in the longitudinal direction of the top surface 2a of the intake port 2, in order to ensure wall thicknesses corresponding to amounts of escapes from spaces such as the port injector mounting portion 2c, the intake valve insertion portion 2d, and the port injector insertion hole 17. Further, the water jacket 48 of each of the intake ports 2 is formed into a shape in which a cutout portion 49 for ensuring a wall thickness corresponding to an amount of an escape from the cylinder direct injection injector insertion hole 18 is formed in the region which covers the undersurface 2b of the intake port 2. The cutout portion 49 is formed into a shape in which the water jacket 48 is cut out from the end portion at the side of the cylinder head side surface to the central side, in a region in a central portion in the longitudinal direction of the undersurface 2b of the intake port 2. However, the water jacket 48 is not divided into two water jackets by the cutout portion 49. That is to say, the water jacket 48 continues in a region at the cylinder head central side of the undersurface 2b of the intake port 2.

According to the water jacket 48 which is configured as above, even when the cylinder direct injection injector insertion hole 18 is formed in the periphery of the intake port 2 in the cylinder head, the water jackets 48 of the cooling water channel 47 in embodiment 4 can widely cover the peripheries of the respective intake ports 2 while satisfying constraints in the structure such as the escape from the space. Further, each of the water jackets 48 which cover the respective intake ports 2 is not divided into two, and therefore, the cooling water can be discharged from the single connection path 45.

In the cylinder head of embodiment 4 described above, the water jacket 48 corresponds to the “intake port cooling water jacket” in the first invention, the second reference surface S1 corresponds to the “central trajectory surface” in the first invention, the main channel 41 corresponds to the “cooling water supplying main channel” in the first invention, and the branch channel 44 corresponds to the “cooling water supplying branch channel” in the first invention. Further, in the cylinder head of embodiment 4 described above, the connection path 45 corresponds to the “cooling water discharging channel” in the fourteenth invention. Further, in the cylinder head of embodiment 4 described above, the auxiliary channel 46 corresponds to the “auxiliary channel” in the fifteenth invention.

### Embodiment 5

Next, embodiment 5 of the present invention will be described with use of the drawings. A cylinder head in embodiment 5 is the same as the cylinder head in embodiment 1 in regard with a basic configuration thereof, except for a shape of an intake port, and the point that the port injector insertion hole 17 is not formed. The intake port 2 in embodiment 5 is of a configuration in which the intake port which has a single opening branches into the two branch ports 2L and 2R halfway, as shown in FIG. 11 or FIG. 12, for example. The intake port 2 is configured so that a sectional shape at a time of being cut perpendicularly to a central trajectory is in an elliptic shape which extends along the longitudinal direction of the cylinder head, at the side of the cylinder head side surface from a position where the intake port 2 branches into the two branch ports 2L and 2R. However, the sectional shape of the intake port 2 is not limited to this, and may be formed into another shape such as a perfect circle or an oval. Further, the intake port 2 in embodiment 5 is of a type in which the port injector mounting portion 2c is not formed.

With respect to the other basic configuration of the cylinder head of embodiment 5, the explanation of the basic configuration of the cylinder head of embodiment 1 is directly cited, and redundant explanation is not made here. Hereinafter, a configuration of the cooling water channel of the cylinder head of embodiment 5 will be described. Explanation is made with use of perspective views in which the cooling water channel inside the cylinder head is drawn by being seen through. Further, in the respective drawings, the elements common to those in embodiment 1 are assigned with the same reference signs.

### <Configuration of Cooling Water Channel of Cylinder Head of Embodiment 5>

### <<Shape of Cooling Water Channel Seen in Perspective Views>>

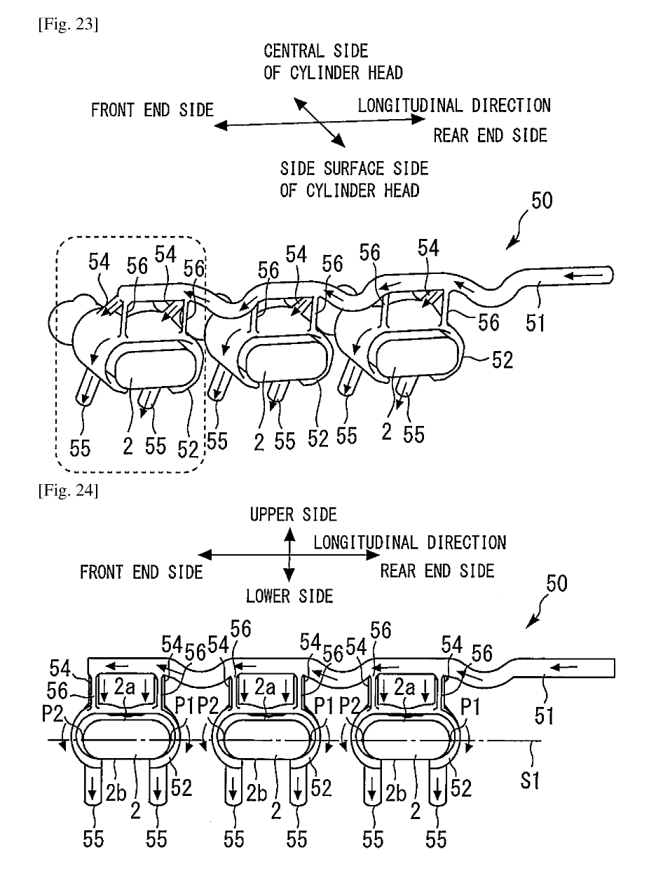

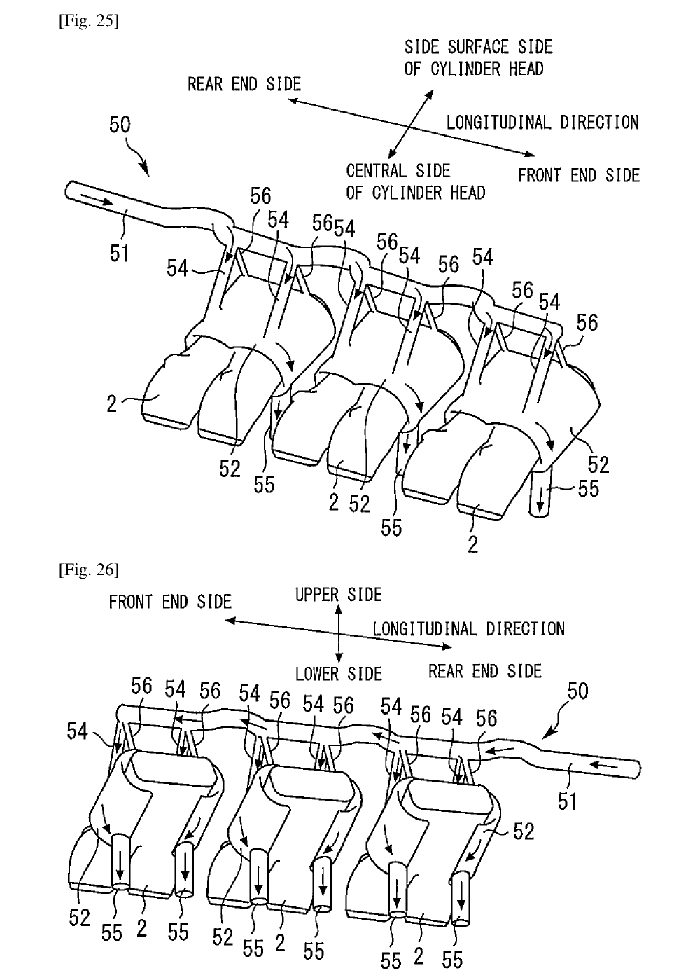

A shape of the cooling water channel that the cylinder head in embodiment 5 has will be described with use of FIG. 23 to FIG. 26. FIG. 23 is a perspective view in which the intake port 2 and a cooling water channel 50 of the cylinder head of embodiment 5 are drawn by being seen through from above an intake side. FIG. 24 is a perspective view in which the intake port 2 and the cooling water channel 50 of the cylinder head of embodiment 5 are drawn by being seen through from a direction along a trajectory central line. FIG. 25 is a perspective view in which the intake port 2 and the cooling water channel 50 are drawn by being see through from above an exhaust side. FIG. 26 is a perspective view in which the intake port 2 and the cooling water channel 50 of the cylinder head of embodiment 5 are drawn by being seen through below the intake side. In FIG. 23 to FIG. 26, a shape of the cooling water channel 50 at a time of being seen with the inside of the cylinder head made transparent, and a positional relation of the cooling water channel 50 and the intake ports 2 are expressed. Note that the arrows in the drawings express flowing directions of the cooling water.

The cooling water channel 50 is provided in peripheries of the intake ports 2 in the cylinder head. A main channel 51 of the cooling water channel 50 extends on an upper part of a row of the intake ports 2, in a direction of the row of the intake ports 2, that is, in the longitudinal direction of the cylinder head.

The cooling water channel 50 has a unit structure for each of the intake ports 2. In FIG. 23, a structure of a part that is encircled by a dotted line is the unit structure of the cooling water channel 50. The unit structure includes a water jacket 52 that is placed in a periphery of the intake port 2. The water jacket 52 is configured to integrally cover a range that includes a side surface that includes the reference point P1 and is mainly configured by a curved surface, a side surface that includes the reference point P2 and is mainly configured by a curved surface, and the top surface 2a of the intake port 2, of a wall surface of the intake port 2, in at least any surface of surfaces perpendicular to the central trajectory L2 of the intake port 2. Note that the water jacket 52 of each of the intake ports 2 is formed into a shape that is divided in a region in a wall surface that is mainly configured by a plane of the undersurface 2b of the intake port, in order to ensure a wall thickness corresponding to an amount of an escape from the cylinder direct injection injector insertion hole 18.

According to the water jacket 52 which is configured as above, even when the cylinder direct injection injector insertion hole 18 is formed in the periphery of the intake port 2 in the cylinder head, the water jackets 52 of the cooling water channel 50 in embodiment 5 can widely cover the peripheries of the respective intake ports 2 while satisfying constraints in the structure such as the escape from the space. Further, in the intake port 2 which is a tumble flow generation port, air flows in such a manner as to stick to the side of the top surface 2a of the intake port 2. Therefore, by cooling the top surface 2a of the intake port 2 by the water jacket 52, the air which flows in the intake port 2 can be efficiently cooled.

In a region of each of the water jackets 52 that cover the top surfaces 2a of the respective intake ports 2, respective regions that are at the front end side and the rear end side of the cylinder head with the central trajectory line L2 of the intake port 2 therebetween are each connected to the main channel 51 via branch channels 54. In more detail, the respective branch channels 54 are disposed at positions that are equidistant to the front end side and the rear end side of the cylinder head with the central trajectory line L2 of the intake port 2 therebetween. Further, in two regions of each of the water jackets 52 that cover the undersurfaces 2b of the respective intake ports 2, respective end portions that are located at a lower side and a cylinder head central side are opened to the cylinder block mating surface 1a via connection paths 55. One end of the main channel 51 is opened to the rear end surface 1d of the cylinder head, and the other end is closed inside the cylinder head. The channel at the cooling water introduction side of the circulation system is connected to an opening portion of the main channel 51, and the connection paths 55 which are opened to the cylinder block mating surface 1a communicate with the cooling water channel inlet that is provided in the cylinder head mating surface of the cylinder block. According to the configuration like this, the cooling water that is cooled in the radiator is introduced into the main channel 51. The cooling water which is introduced into the main channel 51 is guided in parallel to the respective water jackets 52 of each of the intake ports 2 through the branch channels 54. In the water jacket 52 of each of the intake ports 2, the cooling water is guided to an upper side of the water jacket 52 via the two branch channels 54. The introduced cooling water flows inside the water jacket 52, and flows to the cooling water channel of the cylinder block via the two connection paths 55 from the lower side of the water jacket 52.

Each of the water jackets 52 is provided with two auxiliary channels 56 that communicate with the main channel 51. The auxiliary channels 56 are channels that are also used as air bleeders, and are each provided at top portions in the vertical direction of the surface of the upper side of the water jacket 52 to the main channel 51. Note that the auxiliary channel 56 is configured as a channel that has a channel sectional area smaller than that of the branch channel 54.

According to the above described configuration shown in FIG. 23 to FIG. 26, the water jackets 52 of the respective intake ports 2 are configured independently, and therefore, the cooling water which receives heat by flowing in the periphery of each of the intake ports 2 does not flow into the peripheries of the other intake ports 2. Consequently, the peripheries of the respective intake ports 2 can be equally cooled, and therefore, variation in the intake air temperatures among the intake ports can be restrained. In particular, in the water jacket 52 in the cooling water channel 50, the cooling water that flows in the main channel 51 is introduced via the two branch channels 54 which are connected to the upper side of the water jacket 52 of each of the intake ports 2, and therefore, variation in the cooling effect can be restrained by introducing the cooling water with an equal temperature from both sides of the water jacket 52. Further, the main channel 51 is disposed in the upper part of the row of the intake ports 2, and therefore, heat reception by the cooling water in the main channel 51 from the cylinder block mating surface 1a is restrained. Consequently, the low-temperature cooling water can be introduced into the water jackets of the respective intake ports 2 from the main channel 51.

Further, according to the above described configuration shown in FIG. 23 to FIG. 26, the auxiliary channels 56 each communicate with the top portions in the vertical direction at both the ends of the upper side of the water jacket 52, and therefore, the air in the water jacket 52 can be caused to escape to the main channel 51 via the auxiliary channels 56. Further, the auxiliary channel 56 is configured as the channel having the channel section smaller than the branch channel 54, and therefore, the cooling water can be caused to flow efficiently into the water jacket 52 by restraining introduction of the cooling water from the auxiliary channels 56.

Incidentally, in the cylinder head of embodiment 5 of the present invention described above, the water jacket 52 is configured to integrally cover the range of the side surface which includes the reference point P1 and is mainly configured by the curved surface, the top surface 2a of the intake port 2, and the side surface which includes the reference point P2 and is configured by the curved surface, of the wall surface of the intake port 2, in at least any surface of surfaces perpendicular to the central trajectory L2 of the intake port 2. However, the range of the wall surface of the intake port 2 which is covered with the water jacket 52 is not limited to the above described range, and at least a range of the top surface 2a from the reference point P1 to the reference point P2 can be covered.

Further, in the cylinder head in embodiment 5 described above, the respective branch channels 54 are disposed at the positions which are equidistant to the front end side and the rear end side of the cylinder head with the central trajectory line L2 of the intake port 2 therebetween, but other disposition may be adopted as long as it is in the region of each of the water jackets 52 which cover the top surfaces 2a of the respective intake ports 2. Further, in the cylinder head of embodiment 5 described above, the configuration is adopted, which connects the connection paths 55 to the respective end portions which are located on the lower side and the cylinder head central side, in the two regions of each of the water jackets 52 which cover the undersurfaces 2b of the respective intake ports 2, but other dispositions may be adopted as long as they are in the two regions of each of the water jackets 52 which cover the undersurfaces 2b of the respective intake ports 2.

In the cylinder head of embodiment 5 described above, the water jacket 52 corresponds to the “intake port cooling water jacket” in the first invention, the second reference surface S1 corresponds to the “central trajectory surface” in the first invention, the main channel 51 corresponds to the “cooling water supplying main channel” in the first invention, and the branch channel 54 corresponds to the “cooling water supplying branch channel” in the first invention. Further, in the cylinder head of embodiment 5 described above, the connection path 55 corresponds to the “cooling water discharging channel” in the fourteenth invention. Further, in the cylinder head of embodiment 5 described above, the auxiliary channel 56 corresponds to the “auxiliary channel” in the fifteenth invention.

### Embodiment 6

Next, embodiment 6 of the present invention will be described with use of the drawings. The cylinder head in embodiment 6 is one modification of the cylinder head of embodiment 5. The cylinder head in embodiment 6 differs from the cylinder head in embodiment 5 in the configuration of the cooling water channel, the configuration of the intake port 2 and the point that the cylinder head in embodiment 6 has the port injector insertion hole 17. The intake port 2 in embodiment 6 is of a type in which the port injector mounting portion 2c is formed. Hereinafter, a configuration of the cooling water channel of the cylinder head of embodiment 6 will be described. Explanation is made with use of perspective views in which the cooling water channel inside the cylinder head is drawn by being seen through. Further, in the drawings, the elements common to those in embodiment 5 are assigned with the same reference signs.

### <Configuration of Cooling Water Channel of Cylinder Head of Embodiment 6>

### <<Shape of Cooling Water Channel Seen in Perspective Views>>

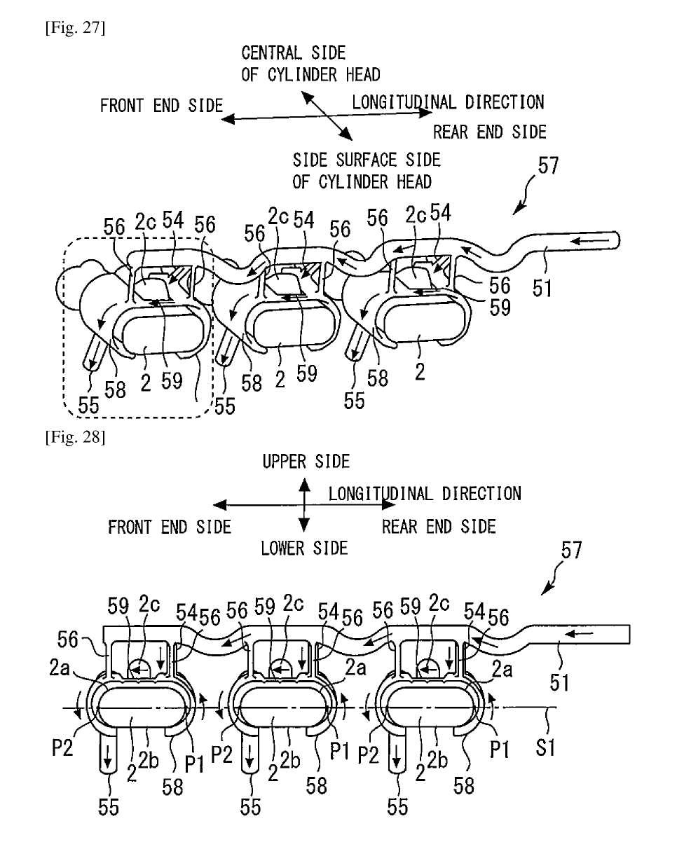

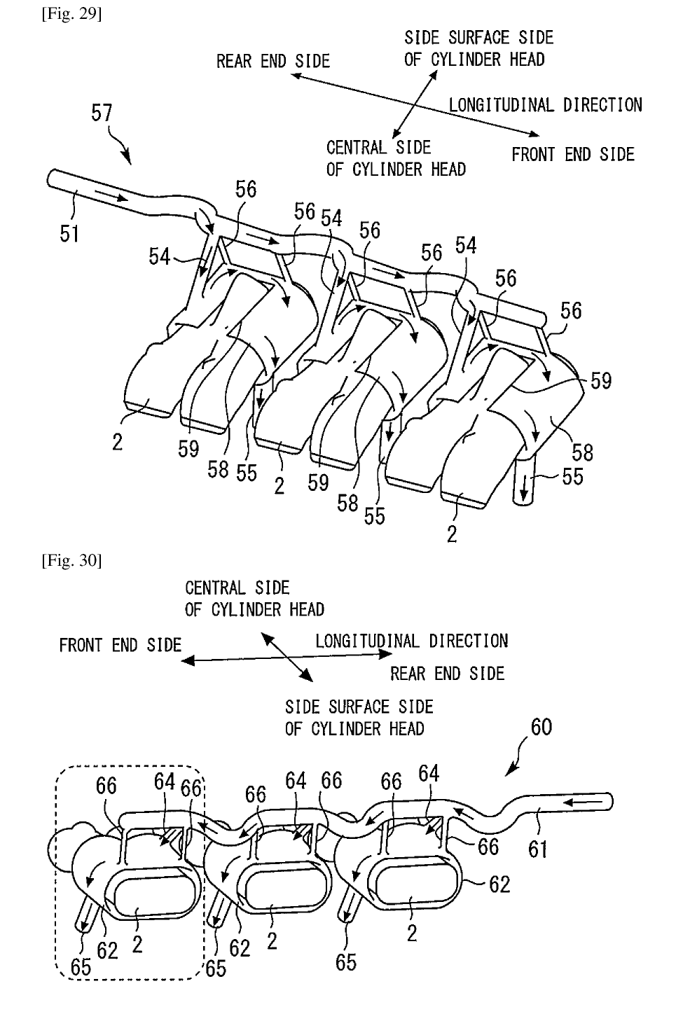

A shape of the cooling water channel that the cylinder head in embodiment 6 has will be described with use of FIG. 27 to FIG. 29. FIG. 27 is a perspective view in which the intake port 2 and a cooling water channel 57 of the cylinder head of embodiment 6 are drawn by being seen through from above an intake side. FIG. 28 is a perspective view in which the intake port 2 and the cooling water channel 57 of the cylinder head of embodiment 6 are drawn by being seen through from a direction along a trajectory central line. Further, FIG. 29 is a perspective view in which the intake port 2 and the cooling water channel 57 of the cylinder head in embodiment 6 are drawn by being seen through from above an exhaust side. In FIG. 27 to FIG. 29, a shape of the cooling water channel 57 at a time of being seen with the inside of the cylinder head made transparent, and a positional relation of the cooling water channel 57 and the intake ports 2 are expressed. Note that the arrows in the drawings express flowing directions of the cooling water.

The cooling water channel 57 has a unit structure for each of the intake ports 2. In FIG. 27, a structure of a part that is encircled by a dotted line is the unit structure of the cooling water channel 57. The unit structure includes a water jacket 58 that is placed in a periphery of the intake port 2. The water jacket 58 is configured to integrally cover a range that includes a wall surface that includes the reference point P1 and is mainly configured by a curved surface, a wall surface that includes the reference point P2 and is mainly configured by a curved surface, and the top surface 2a of the intake port 2, of a wall surface of the intake port 2, in at least any surface of surfaces perpendicular to the central trajectory L2 of the intake port 2. Note that the water jacket 58 of each of the intake ports 2 is formed into a shape that is divided in a region of a wall surface that is mainly configured by a plane of the undersurface 2b of the intake port, in order to ensure a wall thickness corresponding to an amount of an escape from the cylinder direct injection injector insertion hole 18. Further, the water jacket 58 of each of the intake ports 2 is formed into a shape in which a cutout portion 59 for ensuring wall thicknesses of amounts of escapes from the port injector mounting portion 2c and the port injector insertion hole 17 is formed in the region which covers the top surface 2a of the intake port 2. The cutout portion 59 is formed into a shape in which the water jacket 58 is cut out from the end portion at the cylinder head central side to the side surface side, in a region in a central portion in the longitudinal direction of the top surface 2a of the intake port 2. However, the water jacket 58 is not divided into two water jackets by the cutout portion 59. That is to say, the water jacket 58 continues in a region at the cylinder head central side of the top surface 2a of the intake port 2.

Of the region of each of the water jackets 58 which cover the top surfaces 2a of the respective intake ports 2, a region at the rear end side of the cylinder head with respect to the central trajectory line L2 of the intake port 2 connects to the main channel 51 via one branch channel 54. Further, in the range of each of the water jackets 58 which cover the undersurfaces 2b of the respective intake ports 2, a region at the front end side in the longitudinal direction of the cylinder head with respect to the central trajectory line L2 of the intake port 2 is opened to the cylinder block mating surface 1a via the connection path 55. One end of the main channel 51 is opened to the rear end surface 1d of the cylinder head, and the other end is closed inside the cylinder head. The channel at the cooling water introduction side of the circulation system is connected to the opening portion of the main channel 51, and the connection path 55 which is opened to the cylinder block mating surface 1a communicates with the cooling water channel inlet which is provided in the cylinder head mating surface of the cylinder block. According to the configuration like this, cooling water that is cooled in the radiator is introduced into the main channel 51. The cooling water which is introduced into the main channel 51 is guided in parallel to the respective water jackets 52 of each of the intake ports 2 via the branch channels 54. In the water jacket 52 of each of the intake ports 2, the cooling water is guided to the upper side of the water jacket 52 via the single branch channel 54. The guided cooling water flows inside the water jacket 52, and flows to the cooling water channel of the cylinder block via the single connection path 55 from the lower side of the water jacket 52.

According to the water jacket 58 which is configured as above, even when the port injector mounting portion 2c and the port injector insertion hole 17 are formed in the periphery of the intake port 2 in the cylinder heard, each of the water jackets 58 of the cooling water channel 57 in embodiment 6 can widely cover the periphery of each of the intake ports 2 while satisfying constraints in the structure such as escapes from these spaces. Further, each of the water jackets 58 which cover the respective intake ports 2 is not divided into two, and therefore, the cooling water can be discharged from the single connection path 55.

Further, in the water jacket 58 in embodiment 6, the cooling water is introduced from the regions which cover the top surfaces 2a of the respective intake ports 2 and are at the rear end side of the cylinder head with respect to the central trajectory line L2, and is led out from the regions which cover the undersurfaces 2b of the intake ports 2 and are at the front end side of the cylinder head with respect to the central trajectory line L2. According to the configuration like this, a flow of the water which flows from the upper side to the lower side can be formed in the water jacket 58, and therefore, the cooling water can be caused to flow without stagnation.

Note that the cooling water channel 57 in embodiment 6 may adopt a configuration that connects the branch channel 54 to the region at the front end side of the cylinder head with respect to the central trajectory line L2 of the intake port 2, of each of the regions of the water jackets 52 which cover the top surfaces 2a of the respective intake ports 2, and connects the connection path 55 to the region at the rear end side of the cylinder head with respect to the central trajectory line L2 of the intake port 2, in each of the ranges of the water jackets 52 which cover the undersurfaces 2b of the respective intake ports 2.

In the cylinder head of embodiment 6 described above, the water jacket 58 corresponds to the “intake port cooling water jacket” in the first invention, the second reference surface S1 corresponds to the “central trajectory surface” in the first invention, the main channel 51 corresponds to the “cooling water supplying main channel” in the first invention, and the branch channel 54 corresponds to the “cooling water supplying branch channel” in the first invention. Further, in the cylinder head of embodiment 6 described above, the connection path 55 corresponds to the “cooling water discharging channel” in the fourteenth invention. Further, in the cylinder head of embodiment 6 described above, the auxiliary channel 56 corresponds to the “auxiliary channel” in the fifteenth invention.

### Embodiment 7

Next, embodiment 7 of the present invention will be described with use of the drawings. A cylinder head in embodiment 7 is the same as the cylinder head 101 in embodiment 1 in regard with a basic configuration thereof, except for a shape of an intake port, and the point that the port injector insertion hole 17 and the cylinder direct injection injector insertion hole 18 are not formed. Concerning the shape of the intake port, the intake port in embodiment 7 is the same as the intake port in embodiment 5.

With respect to the other basic configuration of the cylinder head of embodiment 7, the explanation of the basic configuration of the cylinder head of embodiment 1 is directly cited, and redundant explanation is not made here. Hereinafter, a configuration of the cooling water channel of the cylinder head in embodiment 7 will be described. Explanation is made with use of perspective views in which the cooling water channel inside the cylinder head is drawn by being seen through. Further, in the respective drawings, the elements common to those in embodiment 1 are assigned with the same reference signs.

### <Configuration of Cooling Water Channel of Cylinder Head of Embodiment 7>

### <<Shape of Cooling Water Channel Seen in Perspective Views>>

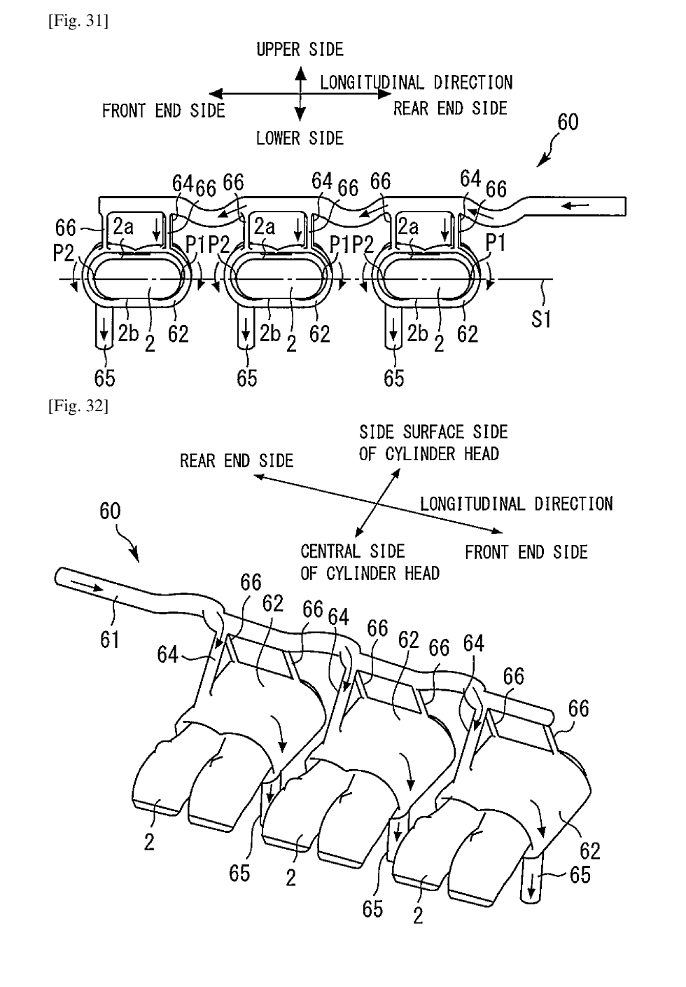

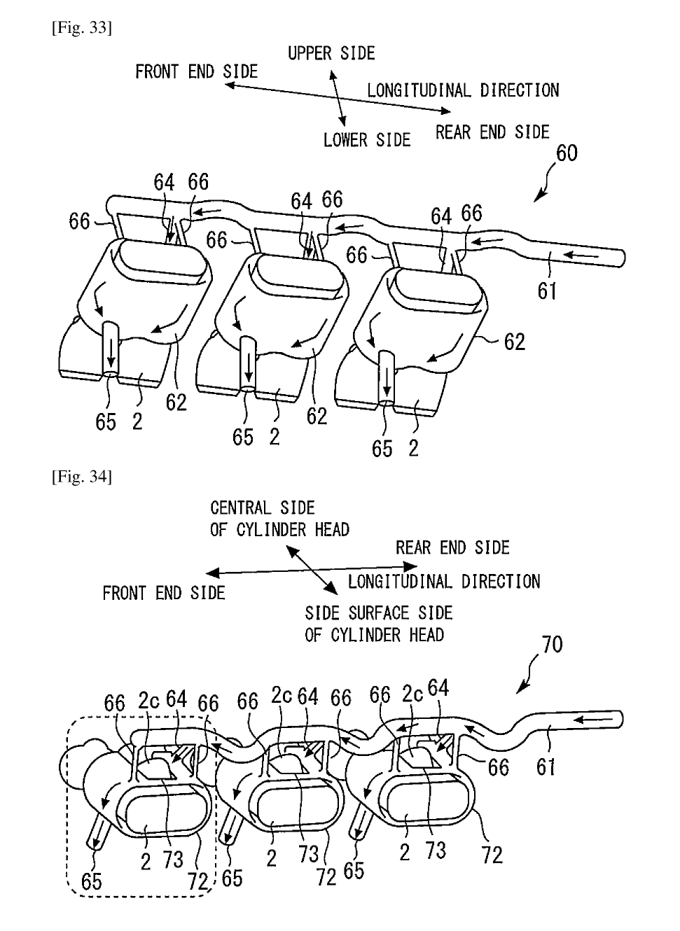

A shape of the cooling water channel that the cylinder head in embodiment 7 has will be described with use of FIG. 30 to FIG. 33. FIG. 30 is a perspective view in which the intake port 2 and a cooling water channel 60 of the cylinder head of embodiment 7 are drawn by being seen through from above an intake side. FIG. 31 is a perspective view in which the intake port 2 and the cooling water channel 60 of the cylinder head of embodiment 7 are drawn by being seen through from a direction along a trajectory central line. FIG. 32 is a perspective view in which the intake port 2 and the cooling water channel 60 of the cylinder head of embodiment 7 are drawn by being see through from above an exhaust side. FIG. 33 is a perspective view in which the intake port 2 and the cooling water channel 60 of the cylinder head of embodiment 7 are drawn by being seen through below the intake side. In FIG. 30 to FIG. 33, a shape of the cooling water channel 60 at a time of being seen with the inside of the cylinder head made transparent, and a positional relation of the cooling water channel 60 and the intake ports 2 are expressed. Note that the arrows in the drawings express flowing directions of the cooling water.

The cooling water channel 60 is provided in peripheries of the intake ports 2 in the cylinder head. A main channel 61 of the cooling water channel 60 extends on an upper part of a row of the intake ports 2, in a direction of the row of the intake ports 2, that is, in the longitudinal direction of the cylinder head.

The cooling water channel 60 has a unit structure for each of the intake ports 2. In FIG. 30, a structure of a part that is encircled by a dotted line is the unit structure of the cooling water channel 60. The unit structure includes a water jacket 62 that is placed in a periphery of the intake port 2. The water jacket 62 is configured to cover a whole circumference of the intake port in a range from a vicinity of the inlet of the intake port 2 to a spot short of a region where the intake port 2 branches into the branch ports 2R and 2L. According to the water jacket 62 which is configured like this, the peripheries of the respective intake ports 2 can be widely covered.

In each of regions of the water jackets 62 that cover the top surfaces 2a of the respective intake ports 2, a region that is at the rear end side of the cylinder head with respect to the central trajectory line L2 of the intake port 2 is connected to a main channel 61 via a branch channel 64. Further, in each of regions of the water jackets 62 that cover the undersurfaces 2b of the respective intake ports 2, a position at the front end side and the central side of the cylinder head is opened to the cylinder block mating surface 1a via a connection path 65. One end of the main channel 61 is opened to the rear end surface 1d of the cylinder head, and the other end is closed inside the cylinder head. The channel at the cooling water introduction side of the circulation system is connected to an opening portion of the main channel 61, and the connection path 65 which is opened to the cylinder block mating surface 1a communicates with the cooling water channel inlet that is provided in the cylinder head mating surface of the cylinder block. According to the configuration like this, cooling water that is cooled in the radiator is introduced into the main channel 61. The cooling water which is introduced into the main channel 61 is guided in parallel to the respective water jackets 62 of each of the intake ports 2 through the branch channels 64. In the water jacket 62 of each of the intake ports 2, the cooling water is guided to a rear end side of an upper side of the water jacket 62 via the single branch channel 64. The introduced cooling water flows inside the water jacket 62, and flows to the cooling water channel of the cylinder block via the single connection path 65 from a front end side of the lower side of the water jacket 62.

Each of the water jackets 62 is provided with two auxiliary channels 66 that communicate with the main channel 61. The auxiliary channels 66 are channels that are also used as air bleeders, and are each provided at top portions in the vertical direction of the surface of the upper side of the water jacket 62 to the main channel 61. Note that the auxiliary channel 66 is configured as a channel that has a channel sectional area smaller than that of the branch channel 64.

According to the above described configuration shown in FIG. 30 to FIG. 33, the water jackets 62 of the respective intake ports 2 are configured independently, and therefore, the cooling water which receives heat by flowing in the periphery of each of the intake ports 2 does not flow into the peripheries of the other intake ports 2. Consequently, the peripheries of the respective intake ports 2 can be equally cooled, and therefore, variation in the intake air temperatures among the intake ports can be restrained.

In particular, in the water jackets 62 in the cooling water channel 60, the cooling water is introduced from the regions which cover the top surfaces 2a of the respective intake ports 2 and are at the rear end side of the cylinder head with respect to the central trajectory lines L2, and is led out from the regions which cover the undersurfaces 2b of the respective intake ports 2 and are at the front end side of the cylinder head with respect to the central trajectory lines L2. According to the configuration like this, a flow of water which goes from the upper side to the lower side can be formed in the water jacket 62, and therefore, the cooling water can be caused flow without stagnation.

Further, since the main channel 61 is disposed on the upper part of the row of the intake ports 2, heat reception by the cooling water in the main channel 61 from the cylinder block mating surface 1a is restrained. Consequently, the low-temperature cooling water can be introduced into the water jackets of the respective intake ports 2 from the main channel 61.

Further, according to the above described configuration shown in FIG. 30 to FIG. 33, the auxiliary channels 66 each communicate with the top portions in the vertical direction at both the ends of the upper side of the water jacket 62, and therefore, the air in the water jacket 62 can be caused to escape to the main channel 61 via the auxiliary channels 66. Further, the auxiliary channel 66 is configured as the channel having the channel section smaller than the branch channel 64, and therefore, the cooling water can be caused to flow efficiently in the water jacket 62 by restraining introduction of the cooling water from the auxiliary channel 66.

Incidentally, in the cylinder head of embodiment 7 of the present invention described above, the water jacket 62 is configured to cover the whole circumference of the intake port 2 in the range from the vicinity of the inlet of the intake port 2 to the spot short of the region where the intake port 2 branches into the branch ports 2R and 2L. However, the range of the wall surface of the intake port 2 which is covered with the water jacket 62 is not limited to the above described range, and the whole circumference of the wall surface of the intake port 2 can be covered, in at least any surface of the surfaces perpendicular to the central trajectory L2 of the intake port 2.

Further, in the cylinder head in embodiment 7 described above, each of the branch channels 64 is configured to be connected to the rear end side of the upper side of each of the water jackets 62, but other disposition may be adopted as long as it is in the region of each of the water jackets 62 which cover the top surfaces 2a of the respective intake ports 2. Further, each of the connection paths 65 is configured to be connected to the front end side of the lower side of each of the water jackets 62, but other disposition may be adopted as long as it is in the region of each of the water jackets 62 which cover the undersurfaces 2b of the respective intake ports 2. For example, in the cooling water channel 60 in embodiment 7, such a configuration may be adopted, that connects the branch channel 64 to the region at the front end side of the cylinder head with respect to the central trajectory line L2 of the intake port 2, of the region of each of the water jackets 62 which cover the top surfaces 2a of the respective intake ports 2, and connects the connection path 65 to the region at the rear end side of the cylinder head with respect to the central trajectory line L2 of the intake port 2, of the range of each of the water jackets 62 which cover the undersurfaces 2b of the respective intake ports 2.

In the cylinder head of embodiment 7 described above, the water jacket 62 corresponds to the “intake port cooling water jacket” in the first invention, the second reference surface S1 corresponds to the “central trajectory surface” in the first invention, the main channel 61 corresponds to the “cooling water supplying main channel” in the first invention, and the branch channel 64 corresponds to the “cooling water supplying branch channel” in the first invention. Further, in the cylinder head of embodiment 7 described above, the connection path 65 corresponds to the “cooling water discharging channel” in the fourteenth invention. Further, in the cylinder head of embodiment 7 described above, the auxiliary channel 66 corresponds to the “auxiliary channel” in the fifteenth invention.

### Embodiment 8

Next, embodiment 8 of the present invention will be described with use of the drawings. The cylinder head in embodiment 8 is one modification of the cylinder head of embodiment 7. The cylinder head in embodiment 8 differs from the cylinder head in embodiment 7 in the configuration of the cooling water channel, the configuration of the intake port 2, and the point that the cylinder head in embodiment 8 has the port injector insertion hole 17. The intake port 2 of embodiment 8 is of a type in which the port injector mounting portion 2c is formed. Hereinafter, a configuration of the cooling water channel of the cylinder head of embodiment 8 will be described. Explanation is made with use of perspective views in which the cooling water channel inside the cylinder head is drawn by being seen through. Further, in the drawings, the elements common to those in embodiment 7 are assigned with the same reference signs.

### <Configuration of Cooling Water Channel of Cylinder Head of Embodiment 8>

### <<Shape of Cooling Water Channel Seen in Perspective Views>>

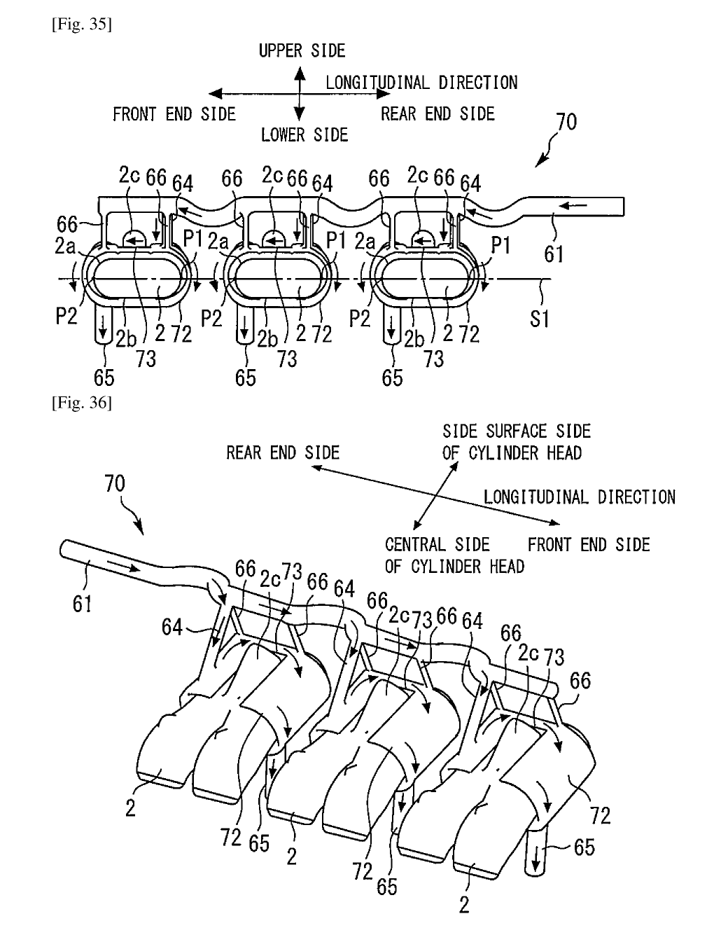

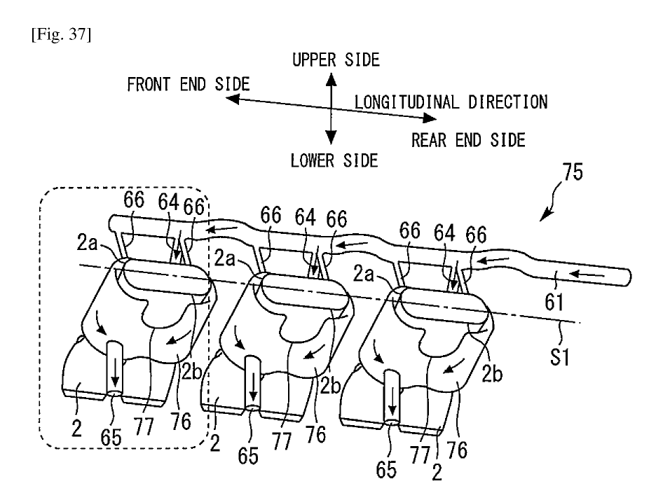

A shape of the cooling water channel that the cylinder head in embodiment 8 has will be described with use of FIG. 34 to FIG. 36. FIG. 34 is a perspective view in which the intake port 2 and a cooling water channel 70 of the cylinder head of embodiment 8 are drawn by being seen through from above an intake side. FIG. 35 is a perspective view in which the intake port 2 and the cooling water channel 70 of the cylinder head of embodiment 8 are drawn by being seen through from a direction along a trajectory central line. Further, FIG. 36 is a perspective view in which the intake port 2 and the cooling water channel 70 of the cylinder head in embodiment 8 are drawn by being seen through from above an exhaust side. In FIG. 34 to FIG. 36, a shape of the cooling water channel 70 at a time of being seen with the inside of the cylinder head made transparent, and a positional relation of the cooling water channel 70 and the intake ports 2 are expressed. Note that the arrows in the drawings express flowing directions of the cooling water.

The cooling water channel 70 has a unit structure for each of the intake ports 2. In FIG. 34, a structure of a part that is encircled by a dotted line is the unit structure of the cooling water channel 70. The unit structure includes a water jacket 72 that is placed in a periphery of the intake port 2. The water jacket 72 is configured to cover a whole circumference of the intake port 2 in a range from a vicinity of the inlet of the intake port 2 to a spot short of a region where the intake port 2 branches into the branch ports 2R and 2L, except for a cutout portion 73. The cutout portion 73 is for ensuring wall thicknesses corresponding to amounts of escapes from the port injector mounting portion 2c and the port injector insertion hole 17, and is in a shape in which the water jacket 72 is cut out from an end portion at the side of the cylinder head side surface to the central side, in a region that covers the central portion in the longitudinal direction of the top surface 2a of the intake port 2.

According to the water jacket 72 which is configured as above, even when the port injector mounting portion 2c and the port injector insertion hole 17 are formed in the periphery of the intake port 2 in the cylinder head, each of the water jackets 72 of the cooling water channel 70 in embodiment 8 can widely cover the periphery of each of the intake ports 2 while satisfying constraints in the structure such as the escapes from these spaces. Further, each of the water jackets 72 which covers the respective intake ports 2 is not divided into two, and therefore, the cooling water can be caused to flow without stagnation.

In the cylinder head of embodiment 8 described above, the water jacket 72 corresponds to the “intake port cooling water jacket” in the first invention, the second reference surface S1 corresponds to the “central trajectory surface” in the first invention, the main channel 61 corresponds to the “cooling water supplying main channel” in the first invention, and the branch channel 64 corresponds to the “cooling water supplying branch channel” in the first invention. Further, in the cylinder head of embodiment 8 described above, the connection path 65 corresponds to the “cooling water discharging channel” in the fourteenth invention. Further, in the cylinder head of embodiment 8 described above, the auxiliary channel 66 corresponds to the “auxiliary channel” in the fifteenth invention.

### Embodiment 9

Next, embodiment 9 of the present invention will be described with use of the drawing. The cylinder head in embodiment 9 is one modification of the cylinder head of embodiment 7. The cylinder head in embodiment 9 differs from the cylinder head in embodiment 7 in the configuration of the cooling water channel, and the point that the cylinder head in embodiment 9 has the cylinder direct injection injector insertion hole 18. Hereinafter, a configuration of the cooling water channel of the cylinder head of embodiment 9 will be described. Explanation is made with use of perspective views in which the cooling water channel inside the cylinder head is drawn by being seen through. Further, in the respective drawings, the elements common to those in embodiment 7 are assigned with the same reference signs.

### <Configuration of Cooling Water Channel of Cylinder Head of Embodiment 9>

### <<Shape of Cooling Water Channel Seen in Perspective View>>

A shape of the cooling water channel that the cylinder head in embodiment 9 has will be described with use of FIG. 37. FIG. 37 is a perspective view in which the intake port 2 and a cooling water channel 75 of the cylinder head of embodiment 9 are drawn by being seen through from below an exhaust side. In FIG. 37, a shape of the cooling water channel 75 at a time of being seen with the inside of the cylinder head made transparent, and a positional relation of the cooling water channel 75 and the intake ports 2 are expressed. Note that the arrows in the drawing express flowing directions of the cooling water.

The cooling water channel 75 has a unit structure for each of the intake ports 2. In FIG. 37, a structure of a part that is encircled by a dotted line is the unit structure of the cooling water channel 75. The unit structure includes a water jacket 76 that is placed in a periphery of the intake port 2. The water jacket 76 is configured to cover a whole circumference of the intake port 2 in a range from a vicinity of the inlet of the intake port 2 to a spot short of a region where the intake port 2 branches into the branch ports 2R and 2L, except for a cutout portion 77. The cutout portion 77 is for ensuring a wall thickness corresponding to an amount of an escape from the cylinder direct injection injector insertion hole 18, and is in a shape in which the water jacket 76 is cut out from an end portion at the side of the cylinder head side surface to the central side, in a region that covers the central portion in the longitudinal direction of the undersurface 2b of the intake port 2.

According to the water jacket 76 which is configured as above, even when the cylinder direct injection injector insertion hole 18 is formed in the periphery of the intake port 2 in the cylinder head, the water jackets 76 of the cooling water channel 75 in embodiment 9 can widely cover the peripheries of the respective intake ports 2 while satisfying constraints in the structure such as the escape from the space. Further, the water jackets 76 which cover the respective intake ports 2 are not divided into two, and therefore, the cooling water can be discharged without stagnation.

In the cylinder head of embodiment 9 described above, the water jacket 76 corresponds to the “intake port cooling water jacket” in the first invention, the second reference surface S1 corresponds to the “central trajectory surface” in the first invention, the main channel 61 corresponds to the “cooling water supplying main channel” in the first invention, and the branch channel 64 corresponds to the “cooling water supplying branch channel” in the first invention. Further, in the cylinder head of embodiment 9 described above, the connection path 65 corresponds to the “cooling water discharging channel” in the fourteenth invention. Further, in the cylinder head of embodiment 9 described above, the auxiliary channel 66 corresponds to the “auxiliary channel” in the fifteenth invention.

### Embodiment 10

Next, embodiment 10 of the present invention will be described with use of the drawing. The cylinder head in embodiment 10 is one modification of the cylinder head of embodiment 7. The cylinder head in embodiment 10 differs from the cylinder head in embodiment 7 in the configuration of the cooling water channel, the point that the cylinder head in embodiment 10 has the port injector insertion hole 17 and the point that the cylinder head in embodiment 10 has the cylinder direct injection injector insertion hole 18. In more detail, the cylinder head in embodiment 10 are common to the cylinder head in embodiment 8 in the point that the port injector insertion hole 17 is included, and the configuration of the cooling water channel which covers the top surface 2a of the intake port 2, and is common to the cylinder head in embodiment 9 in the point that the cylinder direct injection injector insertion hole 18 is included, and the configuration of the cooling water channel which covers the undersurface 2b of the intake port 2.

According to the water jacket which is configured as above, even when the port injector mounting portion 2c, the port injector insertion hole 17 and the cylinder direct injection injector insertion hole 18 are formed in the periphery of the intake port 2 in the cylinder head, the water jackets can widely cover the peripheries of the respective intake ports 2 while satisfying constraints in the structure such as the escapes from these spaces. Further, the water jackets 72 which cover the respective intake ports 2 are not divided into two, and therefore, the cooling water can be caused to flow without stagnation.

### REFERENCE SIGNS LIST

L1: central axis of combustion chamber
L2: central trajectory of intake port
S1: intake port central trajectory surface
S2: surface which is perpendicular to central trajectory
P1: reference point
P2: reference point
1a: cylinder block mating surface
2: intake port
2a: top surface of intake port
2b: undersurface of intake port
2c: port injector mounting portion
2d: intake valve insertion portion
2L, 2R: branch ports
3: exhaust port
4: combustion chamber
5: intake side valve mechanism chamber
6: exhaust side valve mechanism chamber 6
7: intake valve insertion hole
8: exhaust valve insertion hole
11: intake valve
12: ignition plug insertion hole
13, 14: head bolt insertion holes
17: port injector insertion hole
18: cylinder direct injection injector insertion hole
20, 30, 40, 47, 50, 57, 60, 70, 75: cooling water channels
21, 31, 41, 51, 61: main channels
22, 32: first water jackets
23, 33: second water jackets
24, 34, 44, 54, 64: branch channels
25, 35, 45, 55, 65: connection paths
26, 36, 46, 56, 66: auxiliary channels
42, 48, 52, 58, 62, 72, 76: water jackets
59, 73, 77: cutout portions
101: cylinder head

1. A cylinder head for multi-cylinder engine, comprising:
a plurality of intake ports that are provided side by side in a longitudinal direction of the cylinder head;
a plurality of intake port cooling water jackets that are independently provided at the respective plurality of intake ports, and cover at least parts of respective wall surfaces of the plurality of intake ports;
a cooling water supplying main channel that is provided at an opposite side from a side of a cylinder block mating surface of the cylinder head with respect to a central trajectory surface including central trajectories of the plurality of intake ports, and extends in the longitudinal direction of the cylinder head; and
a plurality of cooling water supplying branch channels that connect the cooling water supplying main channel and the respective plurality of intake port cooling water jackets.

2. The cylinder head according to claim 1,
wherein the intake port includes a first branch port and a second branch port that are connected to a common combustion chamber,
the intake port cooling water jacket includes a first water jacket that covers a wall surface which is at the side of the cylinder block mating surface with respect to the central trajectory surface, of a wall surface of the first branch port, and a second water jacket that covers a wall surface which is at an opposite side from the side of the cylinder block mating surface with respect to the central trajectory surface, of a wall surface of the second branch port, in at least one section of sections perpendicular to the central trajectory, and
the first water jacket and the second water jacket are integrally connected in a region between the first branch port and the second branch port.

3. The cylinder head according to claim 2,
wherein the cooling water supplying branch channel is connected to a portion of the first water jacket, which covers a side surface at an opposite side from the second branch port, of the first branch port, and
a cooling water discharging channel is connected to a portion of the second water jacket, which covers a side surface at an opposite side from the first branch port, of the second branch port.

4. The cylinder head according to claim 2, further comprising:
an auxiliary channel that connects a top portion in a vertical direction, of the first water jacket, and the cooling water supplying main channel.

5. The cylinder head according to claim 2, further comprising:
an auxiliary channel that connects a top portion in a vertical direction, of the second water jacket, and the cooling water supplying main channel.

6. The cylinder head according to claim 4,
wherein a channel sectional area of the auxiliary channel is smaller than a channel sectional area of the cooling water supplying branch channel.

7. The cylinder head according to claim 1,
wherein the intake port cooling water jacket includes, in at least one section of sections perpendicular to the central trajectory,
a first side surface water jacket that covers a first position on one side that intersects the central trajectory surface, of a wall surface of the intake port, and
a second side surface water jacket that is configured as a separate piece from the first side surface water jacket, and covers a second position on the other side that intersects the central trajectory surface, of the wall surface of the intake port.

8. The cylinder head according to claim 1,
wherein the intake port cooling water jacket is provided to cover at least a wall surface which is at the side of the cylinder block mating surface with respect the central trajectory surface, of a wall surface of the intake port, in at least one section of sections perpendicular to the central trajectory.

9. The cylinder head according to claim 1,
wherein the intake port cooling water jacket covers at least a wall surface which is at the opposite side from the side of the cylinder block mating surface with respect to the central trajectory surface, of a wall surface of the intake port, in at least one section of sections perpendicular to the central trajectory.

10. The cylinder head according to claim 1,
wherein the intake port cooling water jacket is provided to surround a whole circumference of the intake port.

11. The cylinder head according to claim 7,
wherein the cooling water supplying branch channels are each connected to opposite sides from the side of the cylinder block mating surface with respect to the central trajectory surface, of the first side surface water jacket and the second side surface water jacket, and
cooling water discharging channels are each connected to sides of the cylinder block mating surface with respect to the central trajectory surface, of the first side surface water jacket and the second side surface water jacket.

12. The cylinder head according to claim 11, further comprising:
auxiliary channels that connect respective top portions in the vertical direction of the first side surface water jacket and the second side surface water jacket, and the cooling water supplying main channel.

13. The cylinder head according to claim 12,
wherein the auxiliary channel is a channel with a channel sectional area smaller than a channel sectional area of the cooling water supplying branch channel.

14. The cylinder head according to claim 8,
wherein the cooling water supplying branch channel is connected to an opposite side from the side of the cylinder block mating surface with respect to the central trajectory surface, of the intake port cooling water jacket, and
a cooling water discharging channel is connected to a side of the cylinder block mating surface with respect to the central trajectory surface, of the intake port cooling water jacket.

15. The cylinder head according to claim 14, further comprising:
an auxiliary channel that connects a top portion in the vertical direction of the intake port cooling water jacket, and the cooling water supplying main channel.

16. The cylinder head according to claim 15,
wherein a channel sectional area of the auxiliary channel is smaller than a channel sectional area of the cooling water supplying branch channel.
